(19) United States
(12) Patent Application Publication
(10) Pub. No.: US 2025/0227241 A1
(43) Pub. Date: Jul. 10, 2025

(54) TEMPLATE-MATCHING-BASED SUBBLOCK MOTION REFINEMENT FOR MOTION PREDICTION

(71) Applicant: Alibaba (China) Co., Ltd., Hangzhou (CN)

(72) Inventors: Jie Chen, Beijing (CN); Ru-ling Liao, Sunnyvale, CA (US); Yan Ye, San Diego, CA (US); Xinwei Li, Beijing (CN)

(21) Appl. No.: 19/008,482

(22) Filed: Jan. 2, 2025

Related U.S. Application Data
(60) Provisional application No. 63/619,148, filed on Jan. 9, 2024.

(51) Int. Cl. H04N 19/137; H04N 19/105; H04N 19/176

(52) U.S. Cl. CPC H04N 19/137; H04N 19/105; H04N 19/176

(57) ABSTRACT

Methods and systems implement application of template-matching-based motion refinement on subblocks of coding blocks. A VVC-standard encoder and a VVC-standard decoder can configure one or more processors of a computing system to obtain sub-templates of each subblock of a coding block from respective motion vectors of neighboring subblocks.

### RELATED APPLICATIONS

The present U.S. Non-provisional patent application claims the priority benefit of a first prior-filed U.S. Provisional patent application having the title “TEMPLATE-MATCHING-BASED SUBBLOCK MOTION REFINEMENT FOR MOTION PREDICTION,” Ser. No. 63/619,148 filed Jan. 9, 2024, The entire contents of the identified earlier-filed U.S. Provisional patent applications are hereby incorporated by reference into the present patent application.

### BACKGROUND

In 2020, the Joint Video Experts Team (“JVET”) of the ITU-T Video Coding Expert Group (“ITU-T VCEG”) and the ISO/IEC Moving Picture Expert Group (“ISO/IEC MPEG”) published the final draft of the next-generation video codec specification, Versatile Video Coding (“VVC”). This specification further improves video coding performance over prior standards such as H.264/AVC (Advanced Video Coding) and H.265/HEVC (High Efficiency Video Coding). The JVET continues to propose additional techniques beyond the scope of the VVC standard itself, collected under the Enhanced Compression Model (“ECM”) name.

According to the VVC standard, an encoder and a decoder perform inter-picture prediction by motion vectors (MVs). Inter prediction may use bi-prediction, where two motion vectors, each pointing to its own reference picture, are used to generate the predictor of the current block. According to decoder-side motion vector refinement (“DMVR”), bi-prediction may be performed upon a current CU such that motion information of the current CU includes weighted averaging of two prediction signals, the weight index being inferred from neighboring blocks based on a merge candidate index.

Moreover, at time of writing, the latest draft of ECM (presented at the 36th meeting of the JVET in November 2024 as “Algorithm description of Enhanced Compression Model 15 (ECM 15)”) includes proposals to further implement a new merge candidate list for adaptive decoder-side motion vector refinement. Template matching is performed to refine the motion vector and reorder the merge candidate list. Furthermore, according to subblock-based temporal motion vector prediction (“SbTMVP”), subblock merge candidate lists are implemented.

There is a need to further improve subblock merge candidate lists to refine subblock motion vectors.

### BRIEF DESCRIPTION OF THE DRAWINGS

The detailed description is set forth with reference to the accompanying figures. In the figures, the left-most digit(s) of a reference number identifies the figure in which the reference number first appears. The use of the same reference numbers in different figures indicates similar or identical items or features.

FIGS. 1A and 1B illustrate example block diagrams of, respectively, an encoding process and a decoding process according to an example embodiment of the present disclosure.

FIGS. 2A and 2B illustrate diagrams of the affine motion field of a block with, respectively, four parameters (two control points) and six parameters (three control points). While in the real world there are many kinds of motion (e.g., zoom), according to the VVC standard, a block-based affine transform motion compensation prediction is applied.

FIG. 3 illustrates a diagram of affine motion vectors of luma subblocks calculated for each subblock center sample.

FIG. 4 illustrates deriving motion vectors of subblocks according to subblock-based temporal motion vector prediction (“SbTMVP”) mode.

FIG. 5 illustrates a diagram of control point motion vector inheritance, candidates from which are used to form an affine merge candidate list.

FIGS. 6A and 6B illustrate diagrams of, respectively, inherited candidates from non-adjacent neighbors for the affine merge candidate list and constructed candidates of a first type for the affine merge candidate list.

FIG. 7 illustrates a diagram of locations of constructed affine candidates from adjacent neighbors for the affine merge candidate list.

FIG. 8 illustrates a diagram of locations of constructed affine candidates from non-adjacent neighbors for the affine merge candidate list.

FIG. 9 illustrates a diagram of adjacent 4×4 subblock information of which the motion information is fetched for current coding block affine model regression.

FIG. 10 illustrates motion prediction performed upon a current picture according to bi-prediction, wherein offset blocks of reference pictures are used to calculate a refined motion vector that is in turn used to generate a bi-predicted signal.

FIG. 11 illustrates an example diagram of a search pattern used in a first pass of a multi-pass decoder-side motion vector refinement.

FIG. 12 illustrates a diagram of bilateral matching costs used in a second pass of a multi-pass decoder-side motion vector refinement.

FIG. 13 illustrates finding the closest match between a template in the current picture and a block in a reference picture.

FIGS. 14A and 14B illustrate diamond search patterns utilized in template matching.

FIG. 15 illustrates a flowchart of a template-based refinement process.

FIG. 16 illustrates motion prediction performed upon a current picture 1602 according to bi-prediction.

FIGS. 17A and 17B illustrate deriving reference samples of each sub-template from motion information of the subblocks in the first row and the first column of a current block.

FIG. 18 illustrates a flowchart of a template-based reordering process applied in TM merge mode.

FIG. 19 illustrates sub-templates and subblocks of a coding block.

FIG. 20 illustrates reference sub-templates obtained by deriving an MV of each sub-template of an upper boundary subblock, each sub-template of a left boundary subblock, or both.

FIG. 21 illustrates, for coding blocks, each subblock having different MVs and different prediction direction.

FIGS. 22A, 22B, and 22C illustrate derivation of a template of reference picture list 0, derivation of a template of reference picture list 1, and derivation of a final template by computing a weighted average of the template of reference picture list 0 and the template of reference picture list 1, according to an example embodiment of the present disclosure.

FIGS. 23A, 23B, and 23C illustrate derivation of a template of reference picture list 0, derivation of a template of reference picture list 1, and derivation of a final template by computing a weighted average of the template of reference picture list 0 and the template of reference picture list 1, according to another example embodiment of the present disclosure. FIGS. 23D, 23E, and 23F illustrate alternatives to the derivation of FIGS. 23A, 23B, and 23C according to another example embodiment of the present disclosure.

FIG. 24 illustrates obtaining each sub-template for one upper template of one reference picture list.

FIG. 25 illustrates that, when fusing the sub-templates to get the template, a weighted average is computed for a sub-template and an overlapping sub-template.

FIG. 26 illustrates that the upper boundary subblocks and left boundary subblocks of a coding block have respective motion vectors for obtaining sub-templates.

FIG. 27 illustrates that a same MV offset dMV is added to upper boundary subblocks and left boundary subblock MVs to obtain sub-templates.

FIG. 28 illustrates adding the MV offset dMV to all subblock MVs.

FIGS. 29A and 29B illustrate dividing a search pattern into an integer search pattern and a fractional search pattern.

FIG. 30 illustrates an example system for implementing the processes and methods described herein for implementing template-matching-based motion refinement.

### DETAILED DESCRIPTION

Systems and methods discussed herein are directed to implementing subblock merge candidate lists for motion prediction, and more specifically application of template-matching-based motion refinement on subblocks of a coding block.

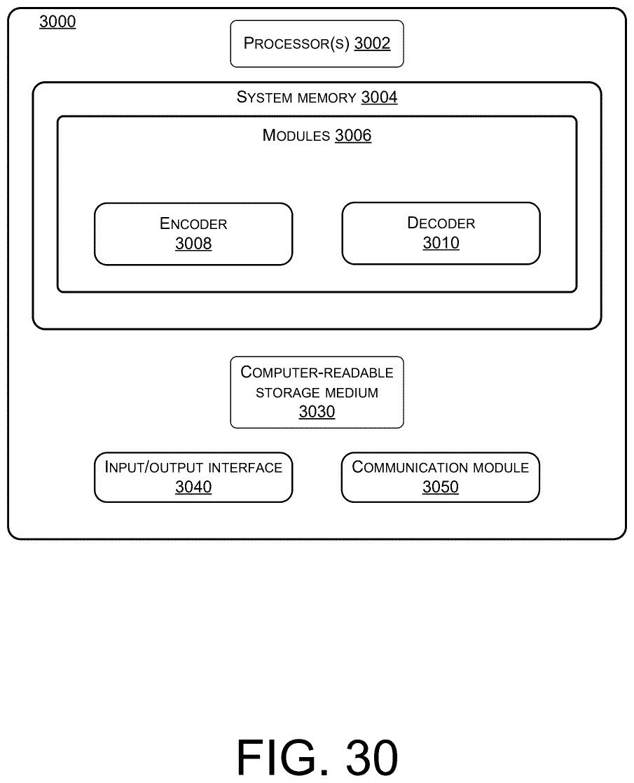

In accordance with the VVC video coding standard (the “VVC standard”) and motion prediction as described therein, a computing system includes at least one or more processors and a computer-readable storage medium communicatively coupled to the one or more processors. The computer-readable storage medium is a non-transient or non-transitory computer-readable storage medium, as defined subsequently with reference to FIG. 30, storing computer-readable instructions. At least some computer-readable instructions stored on a computer-readable storage medium are executable by one or more processors of a computing system to configure the one or more processors to perform associated operations of the computer-readable instructions, including at least operations of an encoder as described by the VVC standard, and operations of a decoder as described by the VVC standard. Some of these encoder operations and decoder operations according to the VVC standard are subsequently described in further detail, though these subsequent descriptions should not be understood as exhaustive of encoder operations and decoder operations according to the VVC standard. Subsequently, a “VVC-standard encoder” and a “VVC-standard decoder” shall describe the respective computer-readable instructions stored on a computer-readable storage medium which configure one or more processors to perform these respective operations (which can be called, by way of example, “reference implementations” of an encoder or a decoder).

Moreover, according to example embodiments of the present disclosure, a VVC-standard encoder and a VVC-standard decoder further include computer-readable instructions stored on a computer-readable storage medium which are executable by one or more processors of a computing system to configure the one or more processors to perform operations not specified by the VVC standard. A VVC-standard encoder should not be understood as limited to operations of a reference implementation of an encoder, but including further computer-readable instructions configuring one or more processors of a computing system to perform further operations as described herein. A VVC-standard decoder should not be understood as limited to operations of a reference implementation of a decoder, but including further computer-readable instructions configuring one or more processors of a computing system to perform further operations as described herein.

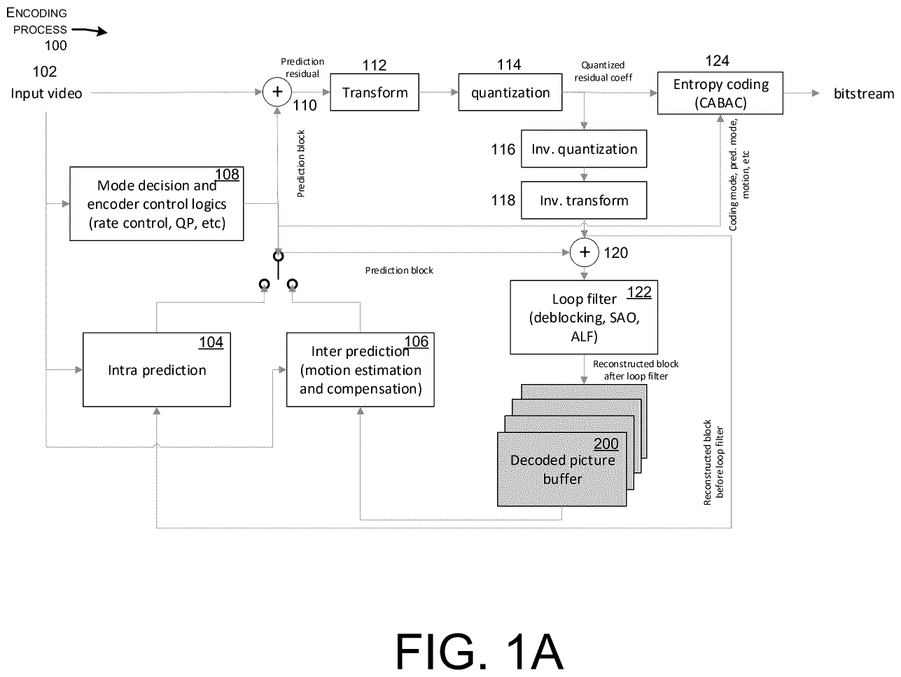

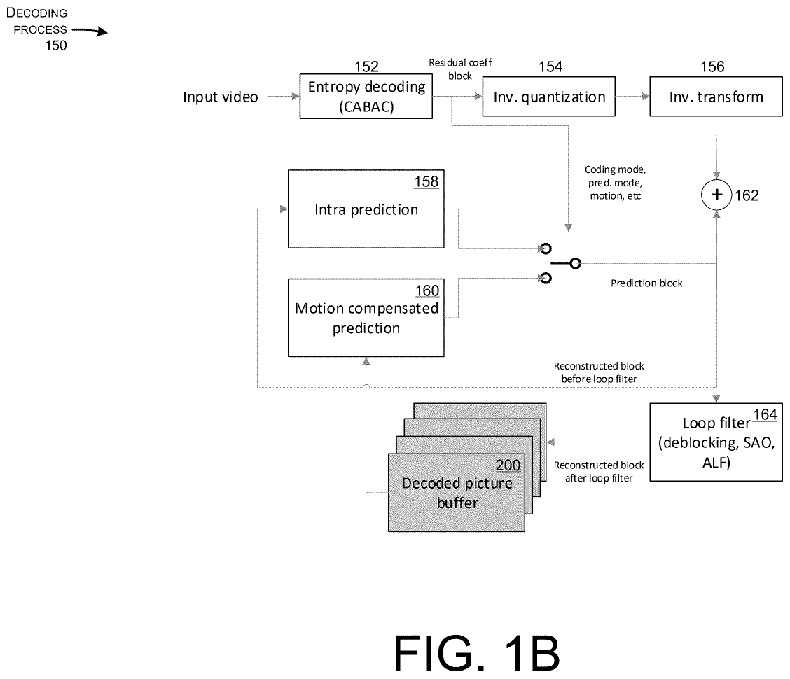

FIGS. 1A and 1B illustrate example block diagrams of, respectively, an encoding process 100 and a decoding process 150 according to an example embodiment of the present disclosure.

In an encoding process 100, a VVC-standard encoder configures one or more processors of a computing system to receive, as input, one or more input pictures from an image source 102. An input picture includes some number of pixels sampled by an image capture device, such as a photosensor array, and includes an uncompressed stream of multiple color channels (such as RGB color channels) storing color data at an original resolution of the picture, where each channel stores color data of each pixel of a picture using some number of bits. A VVC-standard encoder configures one or more processors of a computing system to store this uncompressed color data in a compressed format, wherein color data is stored at a lower resolution than the original resolution of the picture, encoded as a luma (“Y”) channel and two chroma (“U” and “V”) channels of lower resolution than the luma channel.

A VVC-standard encoder encodes a picture (a picture being encoded being called a “current picture,” as distinguished from any other picture received from an image source 102) by configuring one or more processors of a computing system to partition the original picture into units and subunits according to a partitioning structure. A VVC-standard encoder configures one or more processors of a computing system to subdivide a picture into macroblocks (“MBs”) each having dimensions of 16×16 pixels, which may be further subdivided into partitions. A VVC-standard encoder configures one or more processors of a computing system to subdivide a picture into coding tree units (“CTUs”), the luma and chroma components of which may be further subdivided into coding tree blocks (“CTBs”) which are further subdivided into coding units (“CUs”). Alternatively, a VVC-standard encoder configures one or more processors of a computing system subdivide a picture into units of N×N pixels, which may then be further subdivided into subunits. Each of these largest subdivided units of a picture may generally be referred to as a “block” for the purpose of this disclosure.

A CU is coded using one block of luma samples and two corresponding blocks of chroma samples, where pictures are not monochrome and are coded using one coding tree.

A VVC-standard encoder configures one or more processors of a computing system to subdivide a block into partitions having dimensions in multiples of 4×4 pixels. For example, a partition of a block may have dimensions of 8×4 pixels, 4×8 pixels, 8×8 pixels, 16×8 pixels, or 8×16 pixels.

By encoding color information of blocks of a picture and subdivisions thereof, rather than color information of pixels of a full-resolution original picture, a VVC-standard encoder configures one or more processors of a computing system to encode color information of a picture at a lower resolution than the input picture, storing the color information in fewer bits than the input picture.

Furthermore, a VVC-standard encoder encodes a picture by configuring one or more processors of a computing system to perform motion prediction upon blocks of a current picture. Motion prediction coding refers to storing image data of a block of a current picture (where the block of the original picture, before coding, is referred to as an “input block”) using motion information and prediction units (“PUs”), rather than pixel data, according to intra prediction 104 or inter prediction 106.

Motion information refers to data describing motion of a block structure of a picture or a unit or subunit thereof, such as motion vectors and references to blocks of a current picture or of a reference picture. PUs may refer to a unit or multiple subunits corresponding to a block structure among multiple block structures of a picture, such as an MB or a CTU, wherein blocks are partitioned based on the picture data and are coded according to the VVC standard. Motion information corresponding to a PU may describe motion prediction as encoded by a VVC-standard encoder as described herein.

A VVC-standard encoder configures one or more processors of a computing system to code motion prediction information over each block of a picture in a coding order among blocks, such as a raster scanning order wherein a first-decoded block is an uppermost and leftmost block of the picture. A block being encoded is called a “current block,” as distinguished from any other block of a same picture.

According to intra prediction 104, one or more processors of a computing system are configured to encode a block by references to motion information and PUs of one or more other blocks of the same picture. According to intra prediction coding, one or more processors of a computing system perform an intra prediction 104 (also called spatial prediction) computation by coding motion information of the current block based on spatially neighboring samples from spatially neighboring blocks of the current block.

According to inter prediction 106, one or more processors of a computing system are configured to encode a block by references to motion information and PUs of one or more other pictures. One or more processors of a computing system are configured to store one or more previously coded and decoded pictures in a reference picture buffer for the purpose of inter prediction coding; these stored pictures are called reference pictures.

One or more processors are configured to perform an inter prediction 106 (also called temporal prediction or motion compensated prediction) computation by coding motion information of the current block based on samples from one or more reference pictures. Inter prediction may further be computed according to uni-prediction or bi-prediction: in uni-prediction, only one motion vector, pointing to one reference picture, is used to generate a prediction signal for the current block. In bi-prediction, two motion vectors, each pointing to a respective reference picture, are used to generate a prediction signal of the current block.

A VVC-standard encoder configures one or more processors of a computing system to code a CU to include reference indices to identify, for reference of a VVC-standard decoder, the prediction signal(s) of the current block. One or more processors of a computing system can code a CU to include an inter prediction indicator. An inter prediction indicator indicates list 0 prediction in reference to a first reference picture list referred to as list 0, list 1 prediction in reference to a second reference picture list referred to as list 1, or bi-prediction in reference to both reference picture lists referred to as, respectively, list 0 and list 1.

In the cases of the inter prediction indicator indicating list 0 prediction or list 1 prediction, one or more processors of a computing system are configured to code a CU including a reference index referring to a reference picture of the reference picture buffer referenced by list 0 or by list 1, respectively. In the case of the inter prediction indicator indicating bi-prediction, one or more processors of a computing system are configured to code a CU including a first reference index referring to a first reference picture of the reference picture buffer referenced by list 0, and a second reference index referring to a second reference picture of the reference picture referenced by list 1.

A VVC-standard encoder configures one or more processors of a computing system to code each current block of a picture individually, outputting a prediction block for each. According to the VVC standard, a CTU can be as large as 128×128 luma samples (plus the corresponding chroma samples, depending on the chroma format). A CTU may be further partitioned into CUs according to a quad-tree, binary tree, or ternary tree. One or more processors of a computing system are configured to ultimately record coding parameter sets such as coding mode (intra mode or inter mode), motion information (reference index, motion vectors, etc.) for inter-coded blocks, and quantized residual coefficients, at syntax structures of leaf nodes of the partitioning structure.

After a prediction block is output, a VVC-standard encoder configures one or more processors of a computing system to send coding parameter sets such as coding mode (i.e., intra or inter prediction), a mode of intra prediction or a mode of inter prediction, and motion information to an entropy coder 124 (as described subsequently).

The VVC standard provides semantics for recording coding parameter sets for a CU. For example, with regard to the above-mentioned coding parameter sets, pred_mode_flag for a CU is set to 0 for an inter-coded block, and is set to 1 for an intra-coded block; general_merge_flag for a CU is set to indicate whether merge mode is used in inter prediction of the CU; inter_affine_flag and cu_affine_type_flag for a CU are set to indicate whether affine motion compensation is used in inter prediction of the CU; mvp_l0_flag and mvp_l1_flag are set to indicate a motion vector index in list 0 or in list 1, respectively; and ref_idx_l0 and ref_idx_l1 are set to indicate a reference picture index in list 0 or in list 1, respectively. It should be understood that the VVC standard includes semantics for recording various other information, flags, and options which are beyond the scope of the present disclosure.

A VVC-standard encoder further implements one or more mode decision and encoder control settings 108, including rate control settings. One or more processors of a computing system are configured to perform mode decision by, after intra or inter prediction, selecting an optimized prediction mode for the current block, based on the rate-distortion optimization method.

A rate control setting configures one or more processors of a computing system to assign different quantization parameters (“QPs”) to different pictures. Magnitude of a QP determines a scale over which picture information is quantized during encoding by one or more processors (as shall be subsequently described), and thus determines an extent to which the encoding process 100 discards picture information (due to information falling between steps of the scale) from MBs of the sequence during coding.

A VVC-standard encoder further implements a subtractor 110. One or more processors of a computing system are configured to perform a subtraction operation by computing a difference between an input block and a prediction block. Based on the optimized prediction mode, the prediction block is subtracted from the input block. The difference between the input block and the prediction block is called prediction residual, or “residual” for brevity.

Based on a prediction residual, a VVC-standard encoder further implements a transform 112. One or more processors of a computing system are configured to perform a transform operation on the residual by a matrix arithmetic operation to compute an array of coefficients (which can be referred to as “residual coefficients,” “transform coefficients,” and the like), thereby encoding a current block as a transform block (“TB”). Transform coefficients may refer to coefficients representing one of several spatial transformations, such as a diagonal flip, a vertical flip, or a rotation, which may be applied to a sub-block.

It should be understood that a coefficient can be stored as two components, an absolute value and a sign, as shall be described in further detail subsequently.

Sub-blocks of CUs, such as PUs and TBs, can be arranged in any combination of sub-block dimensions as described above. A VVC-standard encoder configures one or more processors of a computing system to subdivide a CU into a residual quadtree (“RQT”), a hierarchical structure of TBs. The RQT provides an order for motion prediction and residual coding over sub-blocks of each level and recursively down each level of the RQT.

A VVC-standard encoder further implements a quantization 114. One or more processors of a computing system are configured to perform a quantization operation on the residual coefficients by a matrix arithmetic operation, based on a quantization matrix and the QP as assigned above. Residual coefficients falling within an interval are kept, and residual coefficients falling outside the interval step are discarded.

A VVC-standard encoder further implements an inverse quantization 116 and an inverse transform 118. One or more processors of a computing system are configured to perform an inverse quantization operation and an inverse transform operation on the quantized residual coefficients, by matrix arithmetic operations which are the inverse of the quantization operation and transform operation as described above. The inverse quantization operation and the inverse transform operation yield a reconstructed residual.

A VVC-standard encoder further implements an adder 120. One or more processors of a computing system are configured to perform an addition operation by adding a prediction block and a reconstructed residual, outputting a reconstructed block.

A VVC-standard encoder further implements a loop filter 122. One or more processors of a computing system are configured to apply a loop filter, such as a deblocking filter, a sample adaptive offset (“SAO”) filter, and adaptive loop filter (“ALF”) to a reconstructed block, outputting a filtered reconstructed block.

A VVC-standard encoder further configures one or more processors of a computing system to output a filtered reconstructed block to a decoded picture buffer (“DPB”) 200. A DPB 200 stores reconstructed pictures which are used by one or more processors of a computing system as reference pictures in coding pictures other than the current picture, as described above with reference to inter prediction.

A VVC-standard encoder further implements an entropy coder 124. One or more processors of a computing system are configured to perform entropy coding, wherein, according to the Context-Sensitive Binary Arithmetic Codec (“CABAC”), symbols making up quantized residual coefficients are coded by mappings to binary strings (subsequently “bins”), which can be transmitted in an output bitstream at a compressed bitrate. The symbols of the quantized residual coefficients which are coded include absolute values of the residual coefficients (these absolute values being subsequently referred to as “residual coefficient levels”).

Thus, the entropy coder configures one or more processors of a computing system to code residual coefficient levels of a block; bypass coding of residual coefficient signs and record the residual coefficient signs with the coded block; record coding parameter sets such as coding mode, a mode of intra prediction or a mode of inter prediction, and motion information coded in syntax structures of a coded block (such as a picture parameter set (“PPS”) found in a picture header, as well as a sequence parameter set (“SPS”) found in a sequence of multiple pictures); and output the coded block.

A VVC-standard encoder configures one or more processors of a computing system to output a coded picture, made up of coded blocks from the entropy coder 124. The coded picture is output to a transmission buffer, where it is ultimately packed into a bitstream for output from the VVC-standard encoder. The bitstream is written by one or more processors of a computing system to a non-transient or non-transitory computer-readable storage medium of the computing system, for transmission.

In a decoding process 150, a VVC-standard decoder configures one or more processors of a computing system to receive, as input, one or more coded pictures from a bitstream.

A VVC-standard decoder implements an entropy decoder 152. One or more processors of a computing system are configured to perform entropy decoding, wherein, according to CABAC, bins are decoded by reversing the mappings of symbols to bins, thereby recovering the entropy-coded quantized residual coefficients. The entropy decoder 152 outputs the quantized residual coefficients, outputs the coding-bypassed residual coefficient signs, and also outputs the syntax structures such as a PPS and a SPS.

A VVC-standard decoder further implements an inverse quantization 154 and an inverse transform 156. One or more processors of a computing system are configured to perform an inverse quantization operation and an inverse transform operation on the decoded quantized residual coefficients, by matrix arithmetic operations which are the inverse of the quantization operation and transform operation as described above. The inverse quantization operation and the inverse transform operation yield a reconstructed residual.

Furthermore, based on coding parameter sets recorded in syntax structures such as PPS and a SPS by the entropy coder 124 (or, alternatively, received by out-of-band transmission or coded into the decoder), and a coding mode included in the coding parameter sets, the VVC-standard decoder determines whether to apply intra prediction 156 (i.e., spatial prediction) or to apply motion compensated prediction 158 (i.e., temporal prediction) to the reconstructed residual.

In the event that the coding parameter sets specify intra prediction, the VVC-standard decoder configures one or more processors of a computing system to perform intra prediction 158 using prediction information specified in the coding parameter sets. The intra prediction 158 thereby generates a prediction signal.

In the event that the coding parameter sets specify inter prediction, the VVC-standard decoder configures one or more processors of a computing system to perform motion compensated prediction 160 using a reference picture from a DPB 200. The motion compensated prediction 160 thereby generates a prediction signal.

A VVC-standard decoder further implements an adder 162. The adder 162 configures one or more processors of a computing system to perform an addition operation on the reconstructed residuals and the prediction signal, thereby outputting a reconstructed block.

A VVC-standard decoder further implements a loop filter 164. One or more processors of a computing system are configured to apply a loop filter, such as a deblocking filter, a SAO filter, and ALF to a reconstructed block, outputting a filtered reconstructed block.

A VVC-standard decoder further configures one or more processors of a computing system to output a filtered reconstructed block to the DPB 200. As described above, a DPB 200 stores reconstructed pictures which are used by one or more processors of a computing system as reference pictures in coding pictures other than the current picture, as described above with reference to motion compensated prediction.

A VVC-standard decoder further configures one or more processors of a computing system to output reconstructed pictures from the DPB to a user-viewable display of a computing system, such as a television display, a personal computing monitor, a smartphone display, or a tablet display.

Therefore, as illustrated by an encoding process 100 and a decoding process 150 as described above, a VVC-standard encoder and a VVC-standard decoder each implements motion prediction coding in accordance with the VVC specification. A VVC-standard encoder and a VVC-standard decoder each configures one or more processors of a computing system to generate a reconstructed picture based on a previous reconstructed picture of a DPB according to motion compensated prediction as described by the VVC standard, wherein the previous reconstructed picture serves as a reference picture in motion compensated prediction as described herein.

The merge mode is a mode to code the motion information which is to be used in motion compensation for a current inter predicted block. In this mode, motion information of a current block is inherited or borrowed from previously coded blocks, including spatial neighboring blocks, non-adjacent blocks, temporal blocks, and the like. A merge list is constructed both at encoder side and at decoder side, with list entries being filled with motion information of various previously coded blocks. Each merge list entry is called a merge candidate. The candidate selected and used for the current block in motion compensation is indicated by an index which is signaled in a bitstream to a VVC-standard decoder.

Two different types of merge mode are coding block (“CB”)-level merge mode (or “regular merge mode”), and subblock merge mode. For regular merge mode, motion compensation is performed for a whole block, and for subblock merge mode, a current coding block is divided into one or more subblocks, each subblock having its own motion information; thus, motion compensation is performed at subblock level. A subblock merge list is constructed in applying subblock merge mode. There are two kinds of candidates in the subblock merge list: the first type is subblock temporal motion vector predictor (“SbTMVP”), and the second type is an affine merge candidate.

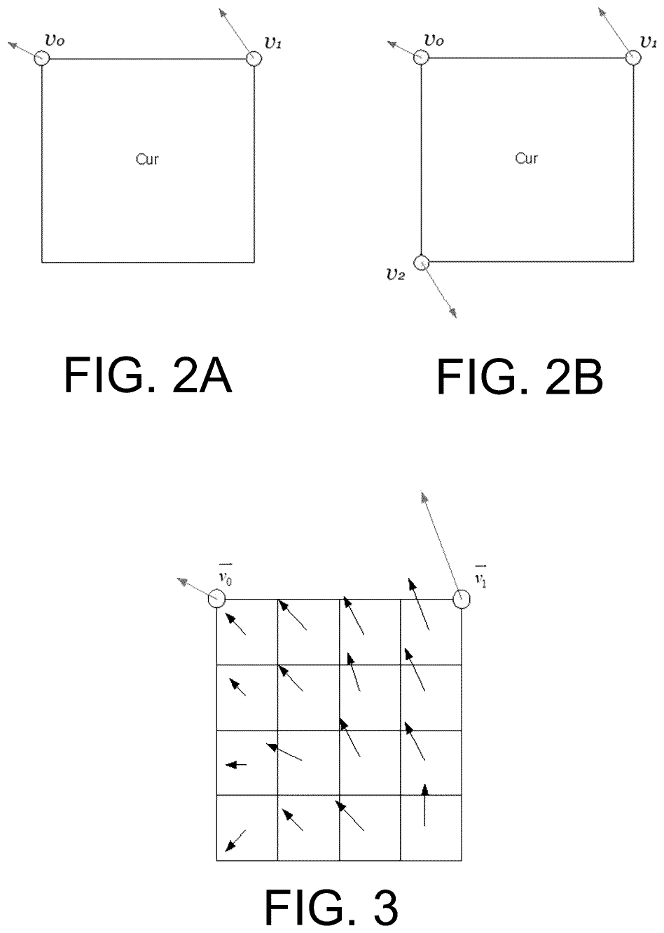

According to HEVC, only a translation motion model is applied for motion compensation prediction (“MCP”). In real-world video content, however, many kinds of motion occur, such as zooming in/out, rotation, perspective changes, and other irregular motions. According to VVC, a block-based affine transform motion compensation prediction is applied. As shown in FIGS. 2A and 2B, the affine motion field of a block is described by motion information of two control point motion vectors (a 4-parameter affine motion model, as illustrated in FIG. 2A) or three control point motion vectors (a 6-parameter affine motion model, as illustrated in FIG. 2B).

In affine motion compensation, for a 4-parameter affine motion model, the motion vector at sample location (x, y) in a block is derived according to Equation 1 below:

$$\{ \begin{matrix}{mv}_{x} = \frac{{mv}_{1 x} - {mv}_{0 x}}{W} x + \frac{{mv}_{0 y} - {mv}_{1 y}}{W} y + {mv}_{0 x} \\ {mv}_{y} = \frac{{mv}_{1 y} - {mv}_{0 y}}{W} x + \frac{{mv}_{1 x} - {mv}_{0 x}}{W} y + {mv}_{0 y}\end{matrix}$$

For a 6-parameter affine motion model, the motion vector at a sample location (x, y) in a block is derived according to Equation 2 below:

$$\{ \begin{matrix}{mv}_{x} = \frac{{mv}_{1 x} - {mv}_{0 x}}{W} x + \frac{{mv}_{2 x} - {mv}_{0 x}}{H} y + {mv}_{0 x} \\ {mv}_{y} = \frac{{mv}_{1 y} - {mv}_{0 y}}{W} x + \frac{{mv}_{2 y} - {mv}_{0 y}}{H} y + {mv}_{0 y}\end{matrix}$$

where (mv₀ₓ, mv_{0y}) is a motion vector of the top-left corner control point, (mv₁ₓ, mv_{1y}) is a motion vector of the top-right corner control point, and (mv₂ₓ, mv_{2y}) is a motion vector of the bottom-left corner control point.

To simplify motion compensation prediction, block-based affine transform prediction is applied. To derive a motion vector of each 4×4 luma subblock, the motion vector of the center sample of each subblock, as shown in FIG. 3, is calculated according to the above Equation 1 and Equation 2, and rounded to 1/16 fraction accuracy. FIG. 3 illustrates a diagram of affine motion vectors of luma subblocks calculated for each subblock center sample. According to ECM, the subblock size is adaptively decided: if the motion vector difference of two neighboring luma subblocks is smaller than a threshold, neighboring luma subblocks will be merged into larger subblocks. If the motion vector difference of the two larger neighboring subblocks is still smaller than the threshold, the larger subblocks will continue to be merged until the motion vector difference of the two neighboring subblocks is larger than the threshold, or until the subblock is equal to the whole block.

After the motion vector of a subblock is derived, the motion compensation interpolation filters are applied to generate a predictor of each subblock based on the derived motion vector. The subblock size of chroma-components is dependent on the size of luma subblock. The MV of a chroma subblock is calculated as an average of the MVs of the top-left and bottom-right luma subblocks in the collocated luma region.

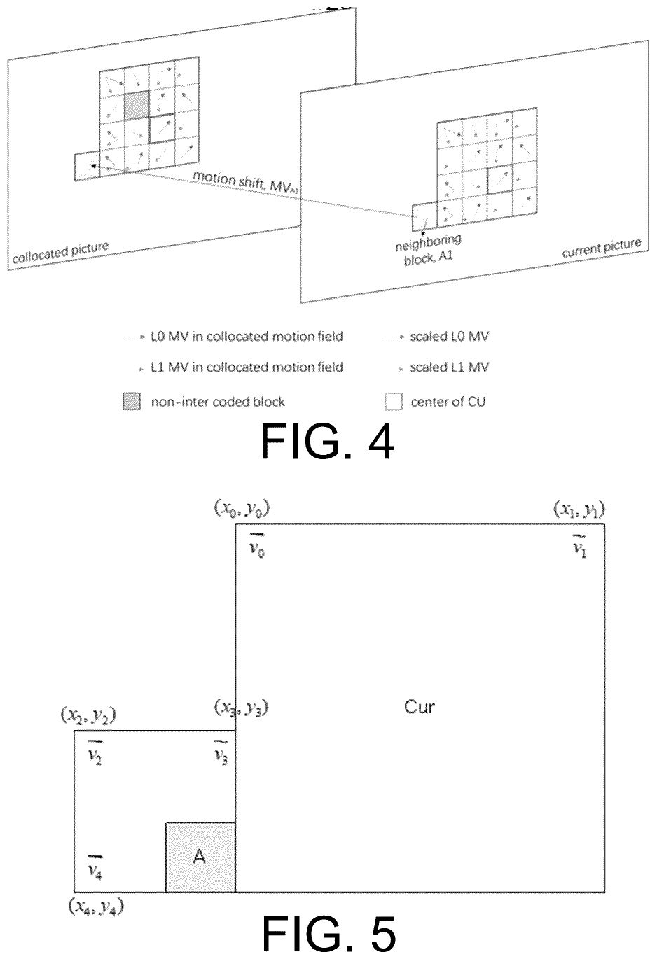

In SbTMVP mode, a coding block is split into 4×4 subblocks and each subblock obtains its own motion vector from the motion field in the collocated picture. The collocated picture is a reference picture which was already encoded or decoded. When obtaining motion vector for each subblock, a motion shift which is derived using the motion vector of the bottom-left neighboring blocks of the current block is applied. As depicted in FIG. 4, the motion shift MV_{A1} is obtained from its neighboring block A1 and is used to derive the motion field in the collocated picture. Then, for each subblock, the motion information of its corresponding subblock in the collocated picture is used to derive the motion information of the subblock.

After the motion information of the collocated subblock is identified, it is converted to the motion vectors and reference indices of the current subblock. The reference index of the subblock is selected from any one of the reference pictures in the reference picture list. The selected reference picture is the one whose scaling factor is the closest to 1. Temporal motion scaling is applied after the reference index is identified. It is noted that when the corresponding subblock in the collocated picture is non-inter coded, such as intra coded or intra block copy (“IBC”) coded, motion information of the center subblock of the coding block is used. As shown in FIG. 4, the shaded, corresponding subblock is non-inter coded: that is, the subblock does not contain any motion information. Thus, the motion information of the center subblock (outlined in bold) is used.

To further improve coding efficiency of SbTMVP, two collocated pictures are utilized, which are the two reference pictures having the least POC distance relative to the current picture. Moreover, instead of only using the motion vector of a left neighboring block to derive a motion shift, multiple locations are included in the derivation and are adaptively determined according to template matching (“TM”) cost. Specifically, two motion shift candidate lists are constructed for the two collocated pictures. The TM cost are calculated to reorder the candidates in the two motion shift candidate lists. Then, the SbTMVP candidates having smaller TM cost in the two motion shift candidate lists are included in a subblock-based merge list.

Affine merge mode (AF_MERGE) can be applied for CBs with both width and height larger than or equal to 8. In this mode, the control point motion vectors (“CPMVs”) of the current CB are generated based on the motion information of the spatial neighboring CBs. When constructing the subblock merge list, the SbTMVP candidates are added first, followed by affine merge candidates. There can be up to fifteen candidates in the list. The following nine types of candidates are used to form the subblock merge candidate list in order: a SbTMVP candidate; inherited candidates from adjacent neighbors; inherited candidates from non-adjacent neighbors; constructed candidates from adjacent neighbors; the second type of constructed affine candidates from non-adjacent neighbors; the first type of constructed affine candidates from non-adjacent neighbors; a regression based affine merge candidate; pairwise affine; and zero MVs (i.e., motion vectors having value 0 for all components).

The inherited affine candidates are derived from an affine motion model of the adjacent or non-adjacent blocks. When an adjacent or non-adjacent affine CB is identified, its control point motion vectors are used to derive the control point motion vector prediction (“CPMVP”) candidate in the affine merge candidate list of the current CB. As shown in FIG. 5 (illustrating a diagram of control point motion vector inheritance, candidates from which are used to form an affine merge candidate list), if the neighbor left bottom block A is coded in affine mode, the motion vectors v₂, v₃ and v₄ of the upper-left corner, the upper-right corner and the bottom-left corner of the CB which contains the block A are obtained. For a block A coded with a 4-parameter affine model, the two CPMVs of the current CB are calculated according to v₂, and v₃. For a block A coded with a 6-parameter affine model, the three CPMVs of the current CB are calculated according to v₂, v₃ and v₄.

For inherited candidates from non-adjacent neighbors, the non-adjacent spatial neighbors are checked based on their distances to the current block, i.e., from near to far. At a specific distance, only the first available neighbor (that is coded with the affine mode) from each side (e.g., the left side and upper side) of the current block is included for inherited candidate derivation.

In the event that the current block is at a boundary of a picture, slice, or tile, adjacent samples on an entire side may not exist. Furthermore, even if upper-adjacent and left-adjacent samples have been encoded or decoded before the current block, right-adjacent and lower-adjacent samples may not be encoded or decoded before the current coding block according to raster scanning order. Other possible coding orders may also change the availability of adjacent samples at the entirety of an upper, left, right, or lower edge. Thus, the present disclosure will refer to nonexistent or non-encoded and non-decoded adjacent samples along an edge as “not available.”

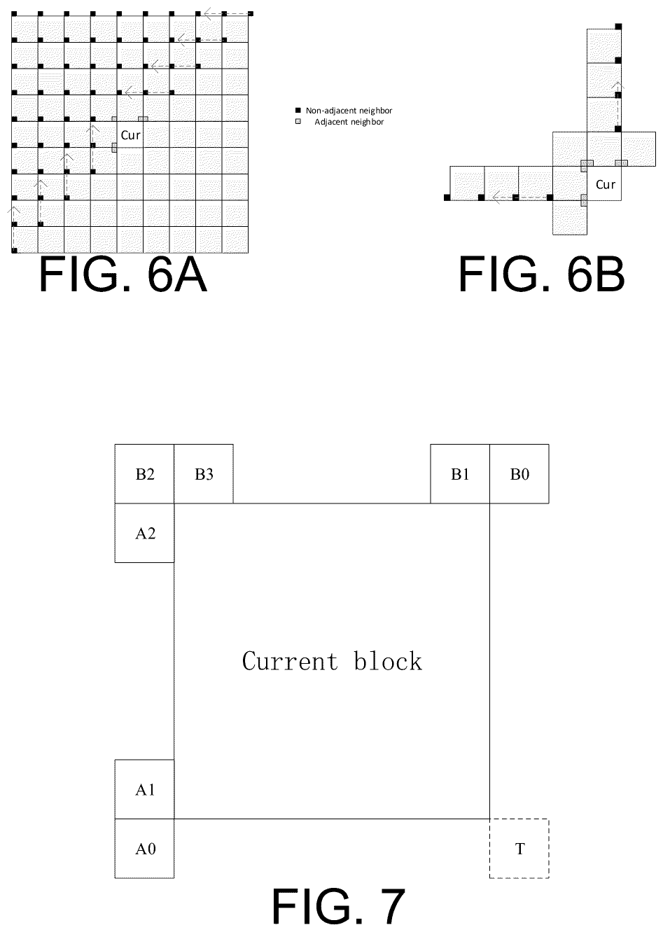

As indicated by the broken-lined arrows in FIG. 6A, the checking orders of the neighbors on the left and upper sides are bottom-to-up and right-to-left, respectively. FIGS. 6A and 6B illustrate diagrams of, respectively, inherited candidates from non-adjacent neighbors for the affine merge candidate list and constructed candidates of a first type for the affine merge candidate list.

Constructed affine candidates from adjacent neighbors are the candidates constructed by combining the neighbor translational motion information of each control point. The motion information for the control points is derived from the specified spatial neighbors and temporal neighbors, as shown in FIG. 7 (FIG. 7 illustrates a diagram of locations of constructed affine candidates from adjacent neighbors for the affine merge candidate list). CPMVₖ (k=1, 2, 3, 4) represents the k-th control point. For CPMV₁, the B2->B3->A2 blocks are checked and the MV of the first available block is used. For CPMV₂, the B1->B0 blocks are checked and for CPMV₃, the A1->A0 blocks are checked. A temporal based motion vector predictor (“TMVP”) is used as CPMV₄ if available.

After MVs of four control points are obtained, affine merge candidates are constructed based on that motion information. The following combinations of control point MVs are used to construct, in order:
{CPMV₁, CPMV₂, CPMV₃}, {CPMV₁, CPMV₂, CPMV₄}, {CPMV₁, CPMV₃, CPMV₄}, {CPMV₂, CPMV₃, CPMV₄}, {CPMV₁, CPMV₂}, {CPMV₁, CPMV₃}
   The combination of 3 CPMVs constructs a 6-parameter affine merge candidate and the combination of 2 CPMVs constructs a 4-parameter affine merge candidate. To avoid a motion scaling process, if the reference indices of control points are different, the related combination of control point MVs is discarded.

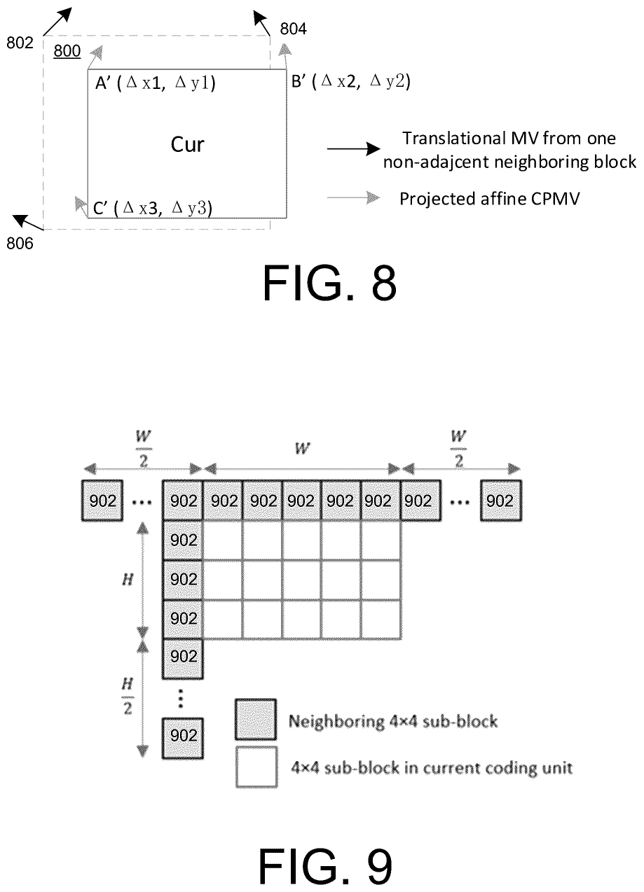

For the first type of constructed candidates from non-adjacent neighbors, as shown in FIG. 6B, the positions of one left and one upper non-adjacent spatial neighbors are first determined independently; after that, the location of the top-left neighbor can be determined accordingly, which can enclose a rectangular virtual block together with the left and upper non-adjacent neighbors. Then, as shown in FIG. 8, the motion information of the three non-adjacent neighbors is used to form the top-left CPMV 802, top-right CPMV 804, and bottom-left CPMV 806 of the virtual block 800, which are finally projected to the current CB to generate the corresponding constructed candidates. FIG. 8 illustrates a diagram of locations of constructed affine candidates from non-adjacent neighbors for the affine merge candidate list.

For the second type of constructed candidates, the affine model parameters are inherited from the non-adjacent spatial neighbors. Specifically, the second type of affine constructed candidates are generated from the combination of 1) the MVs of adjacent neighboring 4×4 blocks; and 2) the affine model parameters inherited from the non-adjacent spatial neighbors as defined in FIG. 6A.

For the regression based affine merge candidates, a subblock motion field from a previously coded affine CB and motion information from adjacent subblocks of a current CB are used as the inputs to the regression process to derive the affine candidates. The previously coded affine CB can be identified from scanning through non-adjacent positions and the affine history-based motion vector predictor (“HMVP”) table. Adjacent subblock information of current CB is fetched from 4×4 sub-blocks 902 represented by the shaded regions as depicted in FIG. 9. For each sub-block, given a reference picture list, the corresponding motion vector and center coordinate of the sub-block may be used. For each affine CB, up to 2 regression based affine candidates can be derived: one with adjacent subblock information, and one without. All the linear-regression-generated candidates are pruned and collected into one candidate sub-group, and a TM cost-based adaptive reordering of merge candidates (“ARMC”) with template matching process is applied when ARMC is enabled. Afterwards, up to N linear-regression-generated candidates are added to the affine merge candidate list when N affine CBs are found.

After inserting all the above merge candidates into the merge candidate list, if the list is still not full, zero MVs are inserted at the end of the list.

Then, ARMC is applied to sort the candidates in the subblock merge list. But, the first SbTMVP candidate is placed as the first entry without reordering, while other SbTMVP candidates are sorted together with other affine candidates. The number of candidates in the subblock-based merge list is set to 30 before ARMC, and is set to 15 after ARMC.

As in merge mode, motion information is directly inherited or borrowed from the previously coded blocks, which may not perfectly match with the current block. Thus, some decoder side refining technologies are adopted to refine the motion derived in the merge mode. The refining technologies includes decoder-side motion vector refinement (“DMVR”) and TM.

The VVC standard adopts bilateral-matching (“BM”)-based DMVR in bi-prediction to increase the accuracy of the MVs of the merge mode. In DMVR, refined MVs are searched near the initial MVs, MV₀ and MV₁, in the reference picture list 0 (“L0”) and reference picture list 1 (“L1”), where the refined MVs are denoted MV₀′ and MV₁′, respectively. The BM method calculates the distortion between the respective two candidate blocks in the reference pictures L0 and L1.

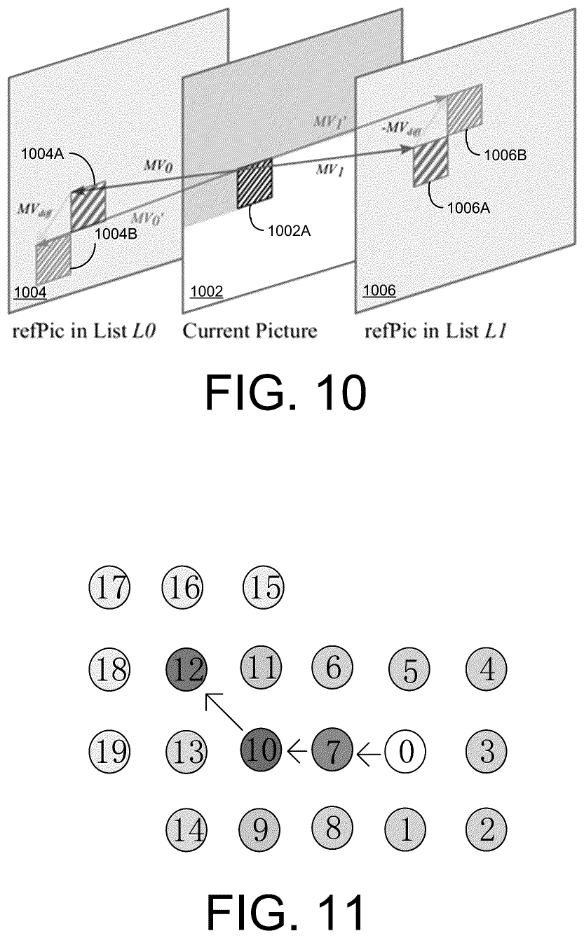

FIG. 10 illustrates motion prediction performed upon a current picture 1002 according to bi-prediction, wherein offset blocks of reference pictures are used to calculate a refined motion vector that is in turn used to generate a bi-predicted signal. The current picture 1002 includes a current block 1002A. Two co-located reference pictures 1004 and 1006, one from reference picture list 0 in a first temporal direction, and one from reference picture list 1 in a second temporal direction, are illustrated in accordance with bi-prediction. Motion information of the current block 1002A refers to a co-located reference block 1004A of the co-located reference picture 1004, and refers to a co-located reference block 1006A of the co-located reference picture 1006. The co-located reference picture 1004 further includes an offset block 1004B near the co-located reference block 1004A, and the co-located reference picture 1006 further includes an offset block 1006B near the co-located reference block 1006A.

As illustrated in FIG. 10, a sum of absolute differences (“SAD”) between the reference block 1004A and the offset block 1004B, and a SAD between the reference block 1006A and the offset block 1006B, are calculated. The MV candidate with the lowest SAD is set as the refined MV and used to generate a bi-predicted signal.

Furthermore, according to the VVC standard, the application of DMVR is restricted and is only applied for the CBs which are coded with the following modes and features: CB-level merge mode with bi-prediction MVs, the bi-prediction MVs pointing to respective reference pictures in different temporal directions (i.e., one reference picture is in the past and another reference picture is in the future) with respect to the current picture; the distances (i.e., the picture order count (“POC”) difference) from two reference pictures to the current picture are same; both reference pictures are short-term reference pictures; the current CB has more than 64 luma samples; both CB height and CB width are larger than or equal to 8 luma samples; bidirectional prediction with coding unit weights (“BCW”) weight index indicates equal weight (it should be understood that, in the context of a weighted averaging bi-prediction equation wherein a weighted averaging of two prediction signals is calculated, an “equal weight” is a weight parameter which causes the two prediction signals to be weighted equally in the equation); weighted bi-prediction (“WP”) is not enabled for the current block; and combined inter-intra prediction (“CIIP”) mode is not used for the current block.

A refined MV derived by DMVR is used to generate the inter prediction samples and also used in temporal motion vector prediction for future pictures coding. The original MV is used in deblocking and also used in spatial motion vector prediction for future CB coding.

Additional features of DMVR are mentioned subsequently.

In DVMR, a refined MV search starts from a search center and encompasses a search range of refined MVs immediately surrounding an initial MV, with the span of the search range delineating a search window, and the range of searched refined MVs being offset obeying the MV difference mirroring rule. In other words, any points that are searched by DMVR, denoted by a candidate MV pair (MV₀, MV₁) obey the following Equation 3 and Equation 4, respectively:

$${{MV}_{0}}^{′} = {MV}_{0} + {MV}_{offset}$$

$${{MV}_{1}}^{′} = {MV}_{1} - {MV}_{offset}$$

where MV_{offset} represents the MV refinement offset between the initial MV and the refined MV in one of the reference pictures. A refined MV search range (also referred to as a “search step” below) is two integer-distance luma samples from the initial MV. A refined MV search includes two stages: an integer sample offset search and a fractional sample refinement.

For the purpose of understanding example embodiments of the present disclosure, all subsequent references to one or more “points” being searched should be understood as referring to individual luma samples of a block or subblock, separated by integer distances.

A 25-point full search is applied for an integer sample offset search. The SAD of the initial MV pair is first calculated. If the SAD of the initial MV pair is smaller than a threshold, the integer sample stage of DMVR terminates. Otherwise, the remaining 24 search points are searched in raster scanning order, calculating the SAD of each search point. The search point with the smallest SAD is selected as an integer-distance refined MV, which is output by the integer sample offset search. To reduce the penalty of the uncertainty of DMVR refinement, the original MV can be favored during the DMVR process. The SAD between the reference blocks referred by the initial MV candidates is decreased by ¼ of the SAD value.

An integer sample offset search can be followed by fractional sample refinement. To reduce computational complexity, a fractional sample refinement is performed by solving a parametric error surface equation, instead of further searching by SAD comparison. The fractional sample refinement is conditionally invoked based on the output of the integer sample offset search. When the integer sample offset search terminates with center having the smallest SAD in either a first iteration or a second iteration search, the fractional sample refinement is further applied. Otherwise, the integer-distance refined MV can be output as a refined MV.

In parametric error surface-based sub-pixel offsets estimation, the center position cost and the costs at four neighboring positions from the center are used to fit a 2-D parabolic error surface as described by Equation 5 below:

$$E ( x , y ) = {A ( x - {x}_{min} )}^{2} + {B ( y - {y}_{min} )}^{2} + C$$

where (xₘᵢₙ,yₘᵢₙ) corresponds to the fractional position with the least cost and C corresponds to the minimum cost value. By solving the above equations using the cost value of the five search points, the (xₘᵢₙ,yₘᵢₙ) is computed respectively according to Equation 6 and Equation 7 below:

$${x}_{min} = ( E ( - 1 , 0 ) - E ( 1 , 0 ) ) / ( 2 ( E ( - 1 , 0 ) + E ( 1 , 0 ) - 2 E ( 0 , 0 ) ) )$$

$${y}_{min} = ( E ( 0 , - 1 ) - E ( 0 , 1 ) ) / ( 2 ( ( E ( 0 , - 1 ) + E ( 0 , 1 ) - 2 E ( 0 , 0 ) ) )$$

The values of xₘᵢₙ and yₘᵢₙ are constrained by default to be between −8 and 8, since all cost values are positive and the smallest value is E(0,0). This corresponds to half-pel offset with 1/16th-pel MV accuracy in VVC. The computed fractional (xₘᵢₙ,yₘᵢₙ) are added to the integer-distance refined MV to obtain a subpixel-accurate refined delta MV. The subpixel-accurate refined delta MV can be output as a refined MV instead of the integer-distance refined MV.

In VVC, resolution of the MVs is 1/16 luma samples. The samples at the fractional position are interpolated using an 8-tap interpolation filter. In DMVR, since refined MV search points are the points immediately surrounding the initial fractional-pel MV with integer sample offset, the samples of those fractional positions need to be interpolated for a DMVR refined MV search. To reduce computational complexity, a bi-linear interpolation filter is used to generate the fractional samples for a DMVR refined MV search. Moreover, by using a bi-linear filter with 2-sample search range, the DVMR does not access more reference samples compared to a standard motion compensation process. After a refined MV is output by a DMVR refined MV search, the standard 8-tap interpolation filter is applied to generate the final prediction. In order to not access more reference samples than the standard motion compensation process, the samples, which are not needed for the interpolation process based on the original MV but are needed for the interpolation process based on the refined MV, will be padded from those available samples.

When the width and/or height of a CB are larger than 16 luma samples, it will be further split into subblocks with width and/or height equal to 16 luma samples. The maximum unit size for the DMVR refined MV search is limited to 16×16.

According to ECM, to further improve coding efficiency, a multi-pass decoder-side motion vector refinement is applied. In the first pass, BM is applied to the coding block. In the second pass, BM is applied to each 16×16 subblock within the coding block. In the third pass, the MV in each 8×8 subblock is refined by applying bi-directional optical flow (“BDOF”). The refined MVs are stored for both spatial and temporal motion vector prediction.

In the first pass, a refined MV is derived by applying BM to a coding block. Similar to DMVR, in bi-prediction, a refined MV is searched near the two initial MVs (MV0 and MV1) in the reference picture lists L0 and L1. The refined MVs (MV0_pass1 and MV1_pass1) are derived near the initial MVs based on the minimum bilateral matching cost between the two reference blocks in L0 and L1.

BM-based refinement performs a local search to derive integer sample precision intDeltaMV. The local search applies a 3×3 square search pattern to loop through the search range [−sHor, sHor] in a horizontal direction and [−sVer, sVer] in a vertical direction, wherein, the values of sHor and sVer are determined by the block dimension, and the maximum value of sHor and sVer is 8, or has other values. For example, in FIG. 11, point 0 is the position to which the initial MV refers and set as a first search center. Thus, the points 1 to 8 surrounding the initial point are searched first and the cost of each position is calculated.

In a first search iteration, point 7 is found having minimum cost, point 7 is set as a second search center, and points 9, 10 and 11 are searched. In a next search iteration, cost of point 10 is found smaller than cost of point 7, 9, 11, so a third search center is set to point 10, and points 12, 13 and 14 are searched. In a next search iteration, point 12 is found having minimum cost among points 6 to 14, so point 12 is set as a fourth search center. In a next search iteration, costs of points 10, 11, 13, and 15 to 19 surrounding the point 12 are all found larger than cost of point 12, so point 12 is an optimal point and the refined MV search terminates, outputting a refined MV corresponding to the optimal point. Thus, FIG. 11 illustrates an example diagram of a search pattern (e.g., a 3×3 square search pattern) used in a first pass of a multi-pass decoder-side motion vector refinement.

The bilateral matching cost can be calculated according to Equation 8 below:

$$bilCost = mvDistanceCost + sadCost$$

wherein sadCost is the SAD between L0 predictor (i.e., a reference block from reference picture L0) and L1 predictor (i.e., a reference block from reference picture L1) on a search point and mvDistanceCost is based on intDeltaMV (i.e., the distance between the search point and the initial point). When the block size cbW (CB width, in pixels)×cbH (CB height, in pixels) is greater than 64, the mean-removed SAD (“MRSAD”) cost function is applied to remove the discrete cosine (“DC”) effect of distortion between reference blocks. When the bilCost at the center point of the 3×3 search pattern has the minimum cost, the intDeltaMV local search terminates. Otherwise, the current minimum cost search point is set as the new center point of the 3×3 search pattern and the search for the minimum cost continues, until the end of the search range is reached.

The existing fractional sample refinement is further applied to derive fractional MV refinement fracDeltaMV, and the final deltaMV is derived as intDeltaMV+fracDeltaMV. The refined MVs after the first pass are then respectively derived according to Equation 9 and Equation 10 below:

$$MV0\_pass1 = {MV}_{0} + deltaMV$$

$$MV1\_pass1 = {MV}_{1} - deltaMV$$

In the second pass, a refined MV is derived by applying BM to a 16×16 grid subblock. For each subblock, a refined MV is searched near the two MVs (MV0 pass1 and MV1 pass1), obtained on the first pass, in the reference picture list L0 and L1. The refined MVs (MV0_pass2(sbIdx2) and MV1_pass2(sbIdx2)) are derived based on the minimum bilateral matching cost between the two reference subblocks in L0 and L1.

For each subblock, BM-based refinement performs a full search to derive integer sample precision intDeltaMV(sbIdx2). The full search has a search range [−sHor, sHor] in a horizontal direction and [−sVer, sVer] in a vertical direction, wherein the values of sHor and sVer are determined by the block dimension, and the maximum value of sHor and sVer is 8 or other values.

The bilateral matching cost can be calculated by applying a cost factor to the sum of absolute transformed differences (“SATD”) cost between two reference subblocks, according to Equation 11 below:

$$bilCost = satdCost \times costFactor$$

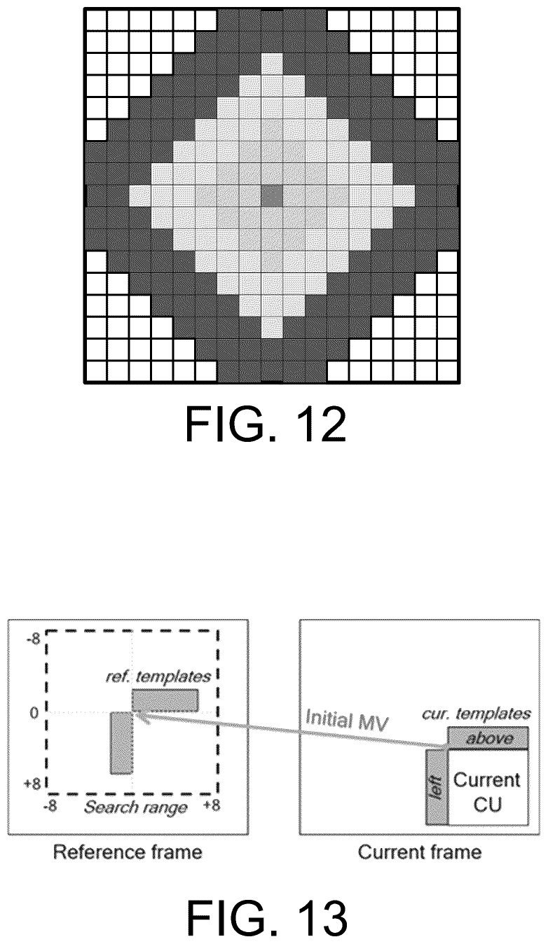

The search area (2×sHor+1)×(2×sVer+1) is divided up to 5 diamond-shaped search regions, as shown in FIG. 12. FIG. 12 illustrates a diagram of bilateral matching costs (each matching cost corresponding to a differently-shaded diamond-shaped search region) used in a second pass of a multi-pass decoder-side motion vector refinement. Each search region is assigned a costFactor, which is determined by the distance intDeltaMV(sbIdx2) between each search point and the starting MV, and each diamond-shaped region is processed in order starting from the center of the search area. In each region, the search points are processed in the raster scan order starting from the top left going to the bottom right corner of the region. When the minimum bilCost within the current search region is less than a threshold equal to sbW (subblock width)×sbH (subblock height), the int-pel full search terminates; otherwise, the int-pel full search continues to the next search region until all search points are examined. Additionally, if the difference between the previous minimum cost and the current minimum cost in the iteration is less than a threshold that is equal to the area of the block, the search terminates.

Furthermore, the bilateral matching costs as described above can also be calculated based on MRSAD instead of SAD, and can also be calculated based on mean-removed sum of absolute transformed differences (“MRSATD”) instead of SATD.

The existing VVC DMVR fractional sample refinement is further applied to derive the final deltaMV(sbIdx2). The refined MVs at second pass are then respectively derived according to Equation 12 and Equation 13 below:

$$MV0\_pass2 ( sbIdx 2 ) = MV0\_pass1 + deltaMV ( sbIdx 2 )$$

$$MV1\_pass2 ( sbIdx 2 ) = MV1\_pass1 - deltaMV ( sbIdx 2 )$$

In the third pass, a refined MV is derived by applying BDOF to an 8×8 grid subblock. For each 8×8 subblock, BDOF refinement is applied to derive scaled Vₓ and V_{y} without clipping starting from the refined MV of the parent subblock of the second pass. The derived bioMv(Vₓ, V_{y}) is rounded to 1/16 sample precision and clipped between −32 and 32.

The refined MVs (MV0_pass3(sbIdx3) and MV1_pass3(sbIdx3)) at third pass are respectively derived according to Equation 14 and Equation 15 below:

$$MV0\_pass3 ( sbIdx 3 ) = MV0\_pass2 ( sbIdx 2 ) + bioMv$$

$$MV1\_pass3 ( sbIdx 3 ) = MV0\_pass2 ( sbIdx 2 ) - bioMv$$

According to ECM, adaptive decoder-side motion vector refinement is an extension of multi-pass DMVR which includes the two new merge modes to refine MV only in one temporal direction-either reference picture L0 or reference picture L1—of the bi prediction for the merge candidates that meet the DMVR conditions. The multi-pass DMVR process is applied for the selected merge candidate to refine the motion vectors; however, either MVD0 or MVD1 is set to zero in the first pass (i.e., PU level) DMVR. Thus, a new merge candidate list is constructed for adaptive decoder-side motion vector refinement. The new merge mode for the new merge candidate list is called BM merge as provided by ECM.

The merge candidates for BM merge mode are derived from spatial neighboring coded blocks, TMVPs, non-adjacent blocks, history-based motion vector predictors (“HMVPs”), pair-wise candidates, similar to regular merge mode. The difference is that only those merge candidates meeting DMVR conditions are added to the merge candidate list. The same merge candidate list is used by the two new merge modes. If the list of BM candidates contains the inherited BCW weights and the DMVR process is unchanged except the computation of the distortion is made using MRSAD or MRSATD if the weights are non-equal and the bi-prediction is weighted with BCW weights. Merge index is coded as in regular merge mode.

TM, as mentioned above, is a decoder-side MV derivation method to refine the motion information of the current coding block by finding the closest match between a template (i.e., top and/or left neighboring blocks of the current coding block) in the current picture and a block (i.e., same size to the template) in a reference picture. As illustrated in FIG. 13, a better MV is searched around the initial motion of the current coding block within a [−8, +8]-pel search range. To achieve efficient combination with AMVR and DMVR, the search step size of TM can be determined based on AMVR mode and TM can be cascaded with DMVR process in merge modes.

Beside merge mode, TM can also be applied in non-merge inter mode which is usually called advanced motion vector prediction (“AMVP”) mode. In AMVP mode, an MVP candidate is determined based on template matching error to select the one which reaches the minimum cost. The cost is calculated as the difference between the current block template and the reference block template. TM is performed only for this particular MVP candidate for MV refinement. Performing TM refines this MVP candidate, starting from full-pel MVD precision (or 4-pel for 4-pel AMVR mode) within a [−8, +8]-pel search range by using iterative diamond search. The AMVP candidate may be further refined by using cross search with full-pel MVD precision (or 4-pel for 4-pel AMVR mode), followed sequentially by half-pel and quarter-pel ones depending on AMVR mode as specified in Table 1 below.

| | AMVR mode | | | | Merge mode | |
|---|---|---|---|---|---|---|
| | | | Half- | Quarter- | | |
| Search pattern | 4-pel | Full-pel | pel | pel | AltIF = 0 | AltIF = 1 |
| 4-pel diamond | v | | | | | |
| 4-pel cross | v | | | | | |
| Full-pel | | v | v | v | v | v |
| diamond | | | | | | |
| Full-pel cross | | v | v | v | v | v |
| Half-pel cross | | | v | v | v | v |
| Quarter-pel | | | | v | v | |
| cross | | | | | | |
| ⅛-pel cross | | | | | v | |

This search process ensures that the MVP candidate still keeps the same MV precision as indicated by the AMVR mode after TM process. In the search process, if the difference between the previous minimum cost and the current minimum cost in the iteration is less than a threshold that is equal to the area of the block, the search process terminates.

In merge mode, similar search method is applied to the merge candidate indicated by the merge index. As Table 1 shows, TM can be performed to the precision of ⅛-pel MVD precision, or can skip those precisions beyond half-pel MVD precision, depending on whether the alternative interpolation filter (that is used when AMVR is of half-pel mode) is used according to merged motion information. Additionally, when TM mode is enabled, template matching may work as an independent process or an extra MV refinement process between block-based and subblock-based bilateral matching (BM) methods, depending on whether BM can be enabled or not according to its enabling condition check.

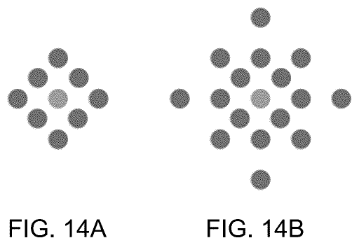

FIGS. 14A and 14B illustrate diamond search patterns utilized in template matching. FIG. 14 illustrates an 8-position diamond search pattern. In each search iteration, the current position (at the center) is set as the search center and the eight neighboring positions (surrounding the center) around the current position are checked, of which the position yields the minimum cost is selected as the next search center. FIG. 14B illustrates a 16-position diamond search pattern, in which 16 neighboring positions are checked in each search iteration. The search process is performed is conducted one round by round until it reaches a maximum search iteration number preset or the search position is over the search range. The early termination algorithm can be adopted. for example, in a search iteration, if the search center has the minimum cost, the search is terminated.

A template matching cost can be computed by computing a difference between a template of the current block and a template of the reference block. SAD or SATD between templates of the current block and the reference block may be computed as the TM cost, i.e., the cost of a candidate motion vector which refers to the reference block. In some other cases, mean removed SAD or mean removed SATD may be computed as the template matching cost.

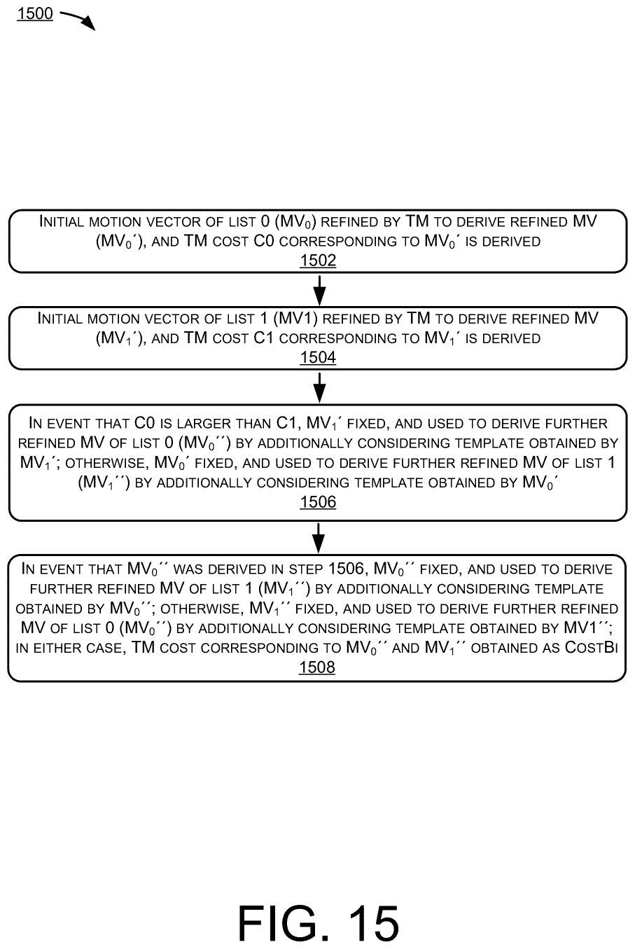

For bi-prediction candidate, two MVs, one for reference picture list 0 and the other for reference picture list 1, are first refined independently and then an iteration process is performed to jointly refine the two MVs. The process is described by the template-based refinement process 1500 of FIG. 15.

At a step 1502, an initial motion vector of list 0 (MV₀) is refined by TM to derive a refined MV (MV₀′), and a TM cost C0 corresponding to MV₀′ is derived.

At a step 1504, an initial motion vector of list 1 (MV₁) is refined by TM to derive a refined MV (MV₁′), and a TM cost C1 corresponding to MV₁′ is derived.

At a step 1506, in the event that C0 is larger than C1, MV₁′ is fixed, and used to derive a further refined MV of list 0 (MV₀″) by additionally considering the template obtained by MV₁′. Otherwise, MV₀′ is fixed, and used to derive a further refined MV of list 1 (MV₁″) by additionally considering the template obtained by MV₀′.

At a step 1508, in the event that MV₀″ was derived in step 1506, MV₀″ is fixed, and used to derive a further refined MV of list 1 (MV₁″) by additionally considering the template obtained by MV₀″. Otherwise, MV₁″ is fixed, and used to derive a further refined MV of list 0 (MV₀″) by additionally considering the template obtained by MV₁″. In either case, a TM cost corresponding to MV₀″ and MV₁″ is obtained as CostBi.

Steps 1506 and 1508 can be performed in additional iterations. After refining of a bi-prediction, the cost of bi-prediction CostBi is compared with uni-prediction cost C0 or C1. If a MV of list 0 was refined in the last iterated step, CostBi is compared with C1; if a MV of list 1 was refined in the last iterated step, CostBi is compared with C0. If CostBi is much larger relative to the uni-prediction cost, the current block is converted to a uni-prediction block.

Moreover, after the merge candidate list is constructed, the merge candidates are reordered according to adaptive reordering of merge candidates with template matching, hereinafter referred to as “ARMC-TM”, wherein merge candidates are adaptively reordered by TM. This reordering is applied to regular merge mode, TM merge mode, and subblock merge mode (excluding the first SbTMVP candidate).

An initial merge candidate list is first constructed according to given checking order, such as spatial neighboring coded blocks, TMVPs, non-adjacent blocks, HMVPs, pairwise candidates, and virtual merge candidates. The candidates in the initial list are divided into several subgroups. Merge candidates in each subgroup are reordered to generate a reordered merge candidate list and the reordering is according to cost values based on template matching. The index of selected merge candidate in the reordered merge candidate list is signaled to the decoder. For simplification, merge candidates in the last but not the first subgroup are not reordered. All the zero candidates from the ARMC reordering process are excluded during the construction of a merge motion vector candidates list. The subgroup size is set to 5 for regular merge mode and TM merge mode. The subgroup size is set to 3 for subblock merge mode.

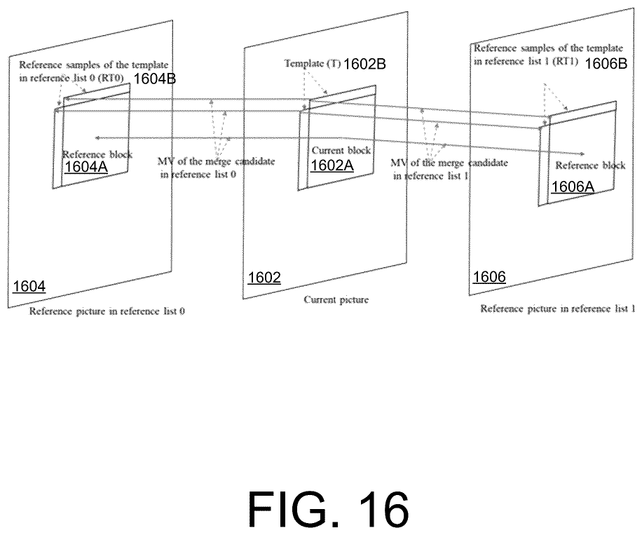

The template matching cost of a merge candidate during the reordering process is measured by the SAD between samples of a template of the current block and their corresponding reference samples. The template comprises a set of reconstructed samples neighboring to the current block. Reference samples of the template are located by the motion information of the merge candidate. When a merge candidate utilizes bi-directional prediction, the reference samples of the template of the merge candidate are also generated by bi-prediction as shown in FIG. 16.

FIG. 16 illustrates motion prediction performed upon a current picture 1602 according to bi-prediction. The current picture 1602 includes a current block 1602A, which includes a template 1602B. Reference samples of the template reference two co-located reference pictures 1604 and 1606, one from reference picture list 0 in a first temporal direction, and one from reference picture list 1 in a second temporal direction, in accordance with bi-prediction. Motion information of the current block 1602A refers to a co-located reference block 1604A of the co-located reference picture 1604, and refers to a co-located reference block 1606A of the co-located reference picture 1606. The template 1602B of the current block 1602A refers to reference samples 1604B of the co-located reference picture 1604, and refers to reference samples 1606B of the co-located reference picture 1606.

When template matching is used to derive the refined motion, the template size is set equal to 1. Only the upper or left template is used during the motion refinement of TM when the block is flat with block width greater than 2 times of height or narrow with height greater than 2 times of width. TM is extended to perform 1/16-pel MVD precision. The first four merge candidates are reordered with the refined motion in TM merge mode.

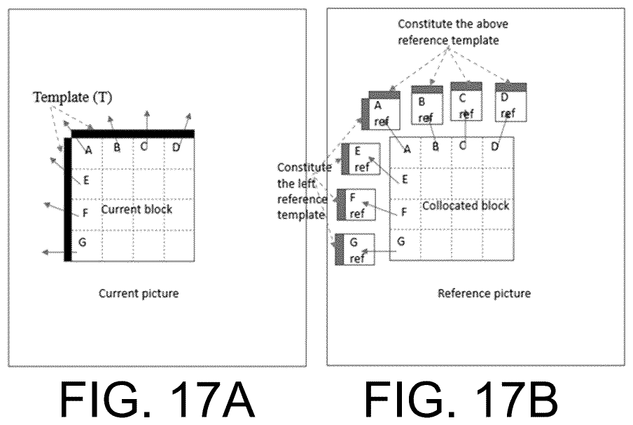

Given Wsub×Hsub as subblock size of an affine merge candidate, the upper template comprises several sub-templates with the size of Wsub×1, and the left template comprises several sub-templates with the size of 1×Hsub. As illustrated by FIGS. 17A and 17B, the motion information of the subblocks in the first row and the first column of current block is used to derive the reference samples of each sub-template.

In the reordering process, a candidate is considered as redundant if the cost difference between a candidate and its predecessor is inferior to a lambda value, e.g., |D1−D2|<λ, where D1 and D2 are the costs obtained during the first ARMC ordering, and λ is the Lagrangian parameter used in the RD criterion at encoder side.

Reordering proceeds as follows:

The minimum cost difference between a candidate and its predecessor among all candidates in the list is determined. If the minimum cost difference is superior or equal to a, the list is considered sufficiently diverse and the reordering stops. If this minimum cost difference is inferior to a, the candidate is considered as redundant, and it is moved at a further position in the list. This further position is the first position where the candidate is sufficiently diverse compared to its predecessor.

This is repeated for a finite number of iterations, while the minimum cost difference is not inferior to X.

Such reordering steps are applied to the regular, TM, BM and subblock merge modes. Similar reordering is applied to the Merge MMVD and sign MVD prediction methods, which also use ARMC for the reordering.

The value of a is set equal to the λ of the rate distortion criterion used to select the best merge candidate at the encoder side for low delay configuration, and to the value λ corresponding to another QP for Random Access configuration. A set of λ values corresponding to each signaled QP offset is provided in the SPS or in the Slice Header for the QP offsets which are not present in the SPS.

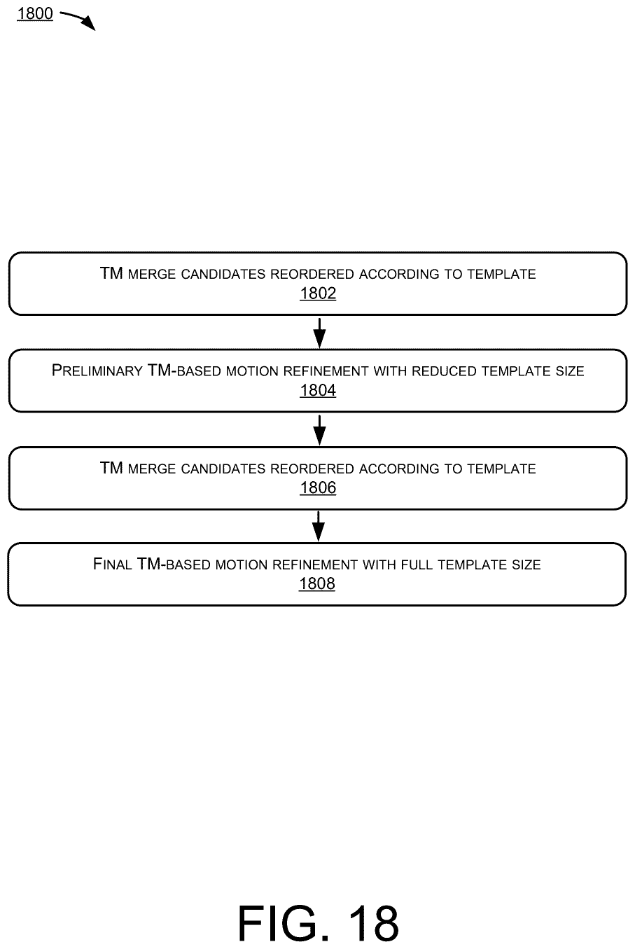

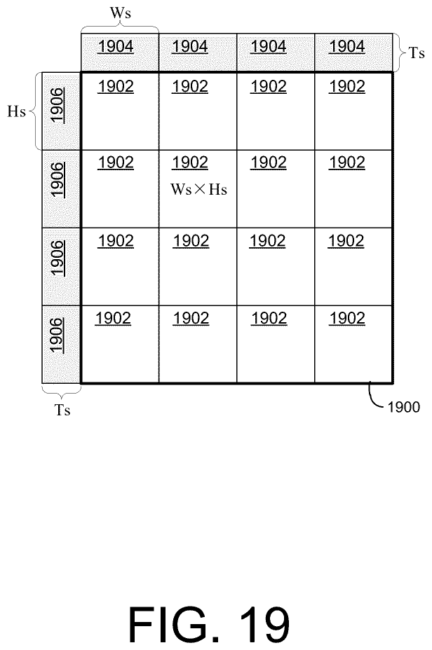

FIG. 18 illustrates a template-based reordering process 1800 applied in TM merge mode.

At a step 1802, the TM merge candidates are reordered before TM refinement.

At a step 1804, a preliminary TM based motion refinement is performed with reduced template size.

At a step 1806, step 1802 is repeated.

At a step 1808, the final TM based refinement is performed with full size of template.

In the preliminary TM based refinement, if multi-pass DMVR is used, only the first pass (i.e., PU level) of multi-pass DMVR is applied, and in the final TM based refinement, both PU level and subblock level of multi-pass DMVR are applied.

The ARMC-TM design is also applicable to the AMVP mode wherein the AMVP candidates are reordered according to the TM cost. For the template matching for advanced motion vector prediction (“TM-AMVP”) mode, an initial AMVP candidate list is constructed, followed by a refinement from TM to construct a refined AMVP candidate list. In addition, an MVP candidate with a TM cost larger than a threshold, which is equal to five times of the cost of the first MVP candidate, is skipped.

When wraparound motion compensation is enabled, the MV candidate shall be clipped with wraparound offset taken into consideration.

Furthermore, MV candidate type-based ARMC is provided. Merge candidates of one single candidate type, e.g., TMVP or non-adjacent MVP (“NA-MVP”), are reordered based on the ARMC TM cost values. The reordered candidates are then added to the merge candidate list. The TMVP candidate type adds more TMVP candidates with more temporal positions and different inter prediction directions to perform the reordering and the selection. Moreover, NA-MVP candidate type is further extended with more spatially non-adjacent positions. The target reference picture of the TMVP candidate can be selected from any one of reference picture in the list according to scaling factor. The selected reference picture is the one whose scaling factor is the closest to 1.

According to the above techniques specified according to VVC and ECM, in a current subblock merge candidate, TM is applied on the affine merge candidate to refine the base MV of the affine model, which is equivalent to refining each subblock MV by adding a same MV offset. However, for subblock merge candidates, TM is only applied to refine the motion shift, i.e., to locate the motion field in the collocated picture, and the subblock MV itself which is actually used in the motion compensation is not refined.

Therefore, example embodiments of the present disclosure provide template-matching-based motion refinement on subblocks of a coding block to select a refined motion vector of a subblock of a coding block based on constructing a sub-template of the subblock of a coding block.

To apply template-matching-based motion refinement on a subblock of a coding block, sub-templates should be constructed first, followed by a final template. Each subblock of the coding block has its own motion vector; thus, the template also comprises sub-templates, each of which is obtained by an MV of a neighboring subblock. If the template size used in TM is equal to Ts and the size of each subblock is Ws×Hs (Ws is width and Hs is height), an upper template comprises several sub-templates with size Ws×Ts, and a left template comprises several sub-templates with size Ts×Hs. FIG. 19 illustrates sub-templates and subblocks of a coding block 1900, in which the unshaded region is a coding block comprising sixteen subblocks 1902, and the shaded region is a template comprising four upper sub-templates 1904 with size of Ws×Ts and four left sub-templates 1906 with size of Ts×Hs. Ts is the size of the template: for example, it could be 1, 2, 3 or 4.

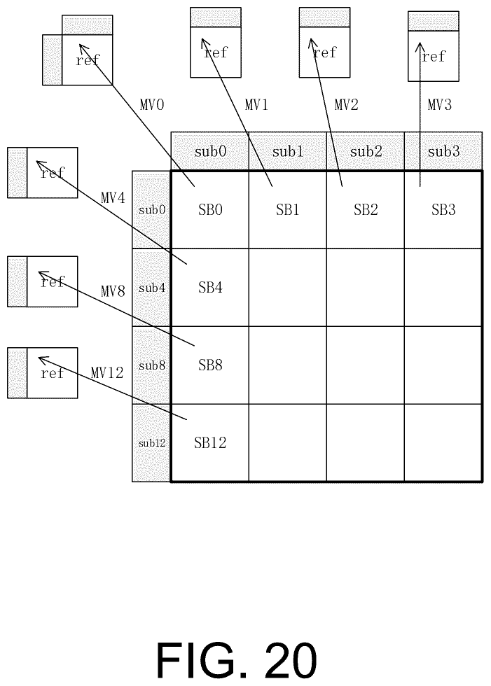

To get the template of the reference block, an MV of each sub-template of an upper boundary subblock, each sub-template of a left boundary subblock, or both is determined. In one example, the MV of each sub-template is the same as that of upper boundary subblocks and left boundary subblocks within the current coding block. FIG. 20 illustrates reference sub-templates obtained by determining MVs of each sub-template of an upper boundary subblock, each sub-template of a left boundary subblock, or both, in which the unshaded subblocks are the subblocks of the current coding block, among which the upper boundary subblocks and left boundary subblocks are marked as SB0, SB1, SB2, SB3, SB4, SB8 and SB12. The shaded subblocks are the sub-templates, marked as sub0, sub1, sub2, sub3, sub4, sub8 and sub12. Each upper boundary subblock and left boundary subblock SBi has a respective motion vector MVi, and thus each sub-template subi also has a respective motion vector MVi. For upper boundary subblocks, an upper reference sub-template is obtained with MVi; for left boundary subblocks, a left reference sub-template is obtained with MVi; and, for an upper and left boundary subblock, an upper and left reference sub-template is obtained with MVi. Thus, the reference sub-templates are also adjacent to the reference subblocks in the reference picture, where each reference subblock is marked as “ref.” For a bi-prediction block, the template of reference picture list 0 and the template of reference picture list 1 are derived, respectively. The template of reference picture list 0 includes sub-templates obtained with MVs of reference picture list 0, and the template of reference picture list 1 includes sub-templates obtained with MVs of reference picture list 1. A final template is derived by computing a weighted average of the template of reference picture list 0 and the template of reference picture list 1.

Alternatively, to get the template of the reference block, an MV of an upper boundary subblock, a left boundary subblock, or both is determined (i.e., MVi as described above).

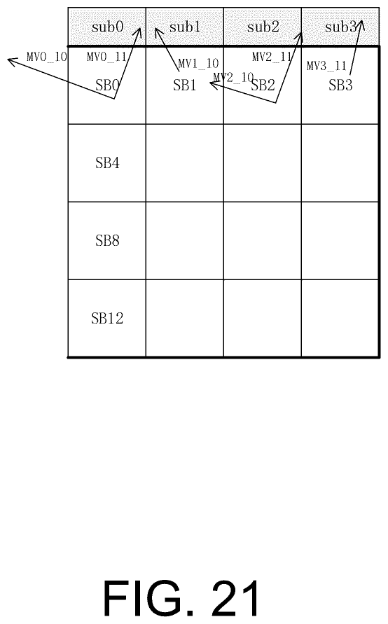

For subblocks of a coding block, each subblock not only has different MVs, but also may have different prediction directions. For example, as illustrated by FIG. 21, SB0 is bi-predicted, having motion vectors of MV0_l0 and MV0_l1 for reference picture list 0 and reference picture list 1, respectively. SB1 is uni-predicted, and only has a motion vector MV1_l0 for reference picture list 0. SB2 is bi-predicted, having motion vectors MV2_l0 and MV2_l1 for reference picture list 0 and reference picture list 1, respectively. SB3 is uni-predicted, and only has motion vector MV3_l1 for reference picture list 1.

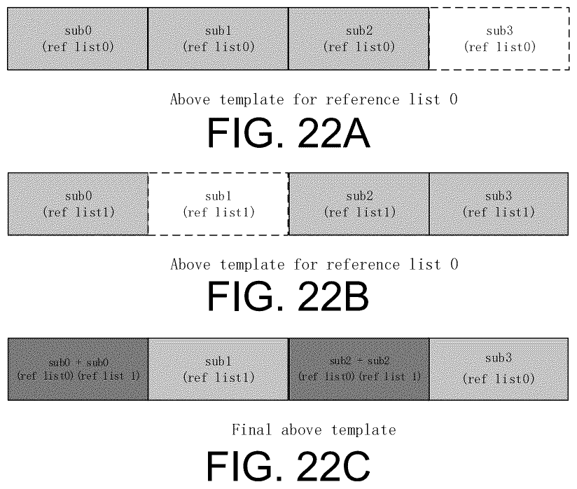

As illustrated by FIG. 22A, when getting the template of reference picture list 0, sub-template sub3 does not exist as SB3 does not have an MV of reference picture list 0, so the upper template for reference picture list 0 only has three sub-templates sub0, sub1 and sub2. As illustrated by FIG. 22B, when getting the template of reference picture list 1, sub-template sub1 does not exist as SB1 does not have an MV of reference picture list 1, so the upper template for reference picture list 1 only has three sub-templates sub0, sub2 and sub3. Broken outlines in FIGS. 22A and 22B indicate a sub-template not existing. By combining sub-templates of reference picture list 0, the template of reference picture list 0 is derived; by combining sub-templates of reference picture list 1, the template of reference picture list 1 is derived.

After the derivation of a template of reference picture list 0 and a template of reference picture list 1, the final template is derived for each bi-predicted subblock by computing a weighted average of the sub-template of reference picture list 0 and the sub-template of reference picture list 1, and derived for each uni-predicted subblock by taking a sub-template derived from a motion vector of reference picture list 0 or a motion vector of reference picture list 1. As illustrated by FIG. 22C, the final sub-templates sub0 and sub2 are combined with two sub-templates of two lists; the final sub-template sub1 is taken directly from sub1 of reference picture list 1; and the final sub-template sub3 is taken directly from sub3 of reference picture list 0. After getting the final template of the reference block, the difference between the final template of the reference block and the template of the current block can be calculated as the TM cost corresponding to the current MVs.

When the motion vector changes, the above process can be performed again to get a new final template of the reference block (if the MVs are changed, the reference block will be different and thus the template of the reference block is also different) with a new TM cost, which can be computed by any difference computing as described above. Both the VVC-standard encoder and VVC-standard decoder perform a MV search process to try different MVs with different TM costs. The MV producing the minimum TM cost is selected as the final refined MV.

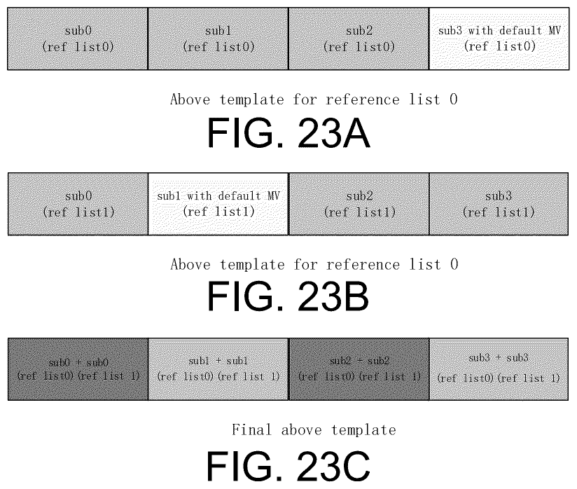

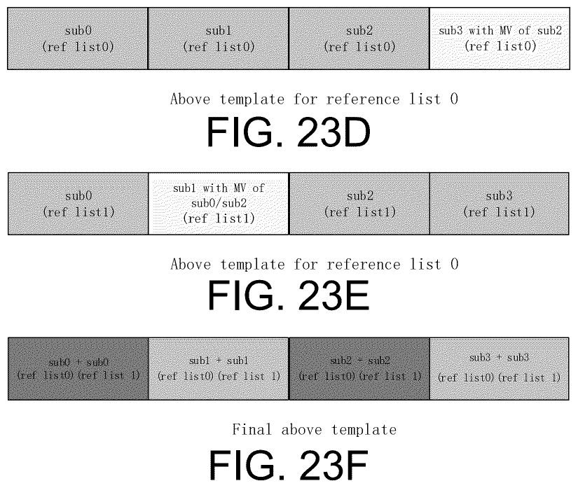

Alternatively, as illustrated by FIGS. 23A, 23B, and 23C, when getting the template for a particular reference picture list, if a sub-template does not exist because the corresponding upper boundary subblock or left boundary subblock does not have an MV for that particular reference picture list, a default MV is used: the default MV is used to get the sub-template for that particular reference picture list for which the upper boundary subblocks or left boundary subblock has no MV. The final template is then derived for each uni-predicted subblock by computing a weighted average of a first sub-template derived from a motion vector of reference picture list 0 or a motion vector of reference picture list 1 and a second sub-template derived from the default motion vector. Lighter-shaded blocks in FIGS. 23A and 23B represent sub-templates obtained by a default MV.

In another example, as illustrated by FIGS. 23D, 23E, and 23F, when getting the template for a particular reference picture list, if a sub-template does not exist because the corresponding upper boundary subblock or left boundary subblock does not have an MV for that particular reference picture list, the MV of the neighboring boundary subblock of corresponding upper boundary subblock or left boundary subblock is used to get the sub-template for that particular reference picture list. In FIG. 23D, the boundary subblock SB3 does not have a MV of reference picture list 0, and thus sub-template 3 (denoted as sub3 and marked with yellow) does not exist. In this case, the MV of reference picture list 0 of SB2 which is the neighboring subblock of SB3 is used to get sub-template3 for reference picture list 0. In FIG. 23E, the boundary subblock SB1 does not have a MV of reference picture list 1, and thus sub-template 1 (denoted as sub1 and marked with yellow) does not exist. In this case, the MV of reference picture list 1 of SB0 or SB2, which is the neighboring subblock of SB1, is used to get sub-template 1 for reference picture list 1.

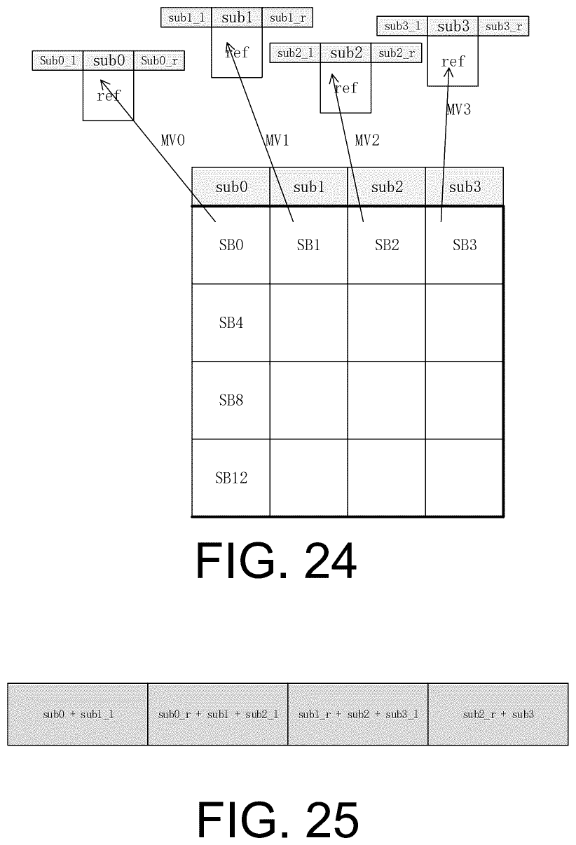

In another embodiment, the adjacent sub-templates are fused with each other to get a more reliable template. FIG. 24 illustrates obtaining each sub-template for one upper template of one reference picture list. SB0, SB1, SB2 and SB3 are the upper boundary subblocks of which the MVs are used to get the reference blocks marked as “ref,” and the sub-templates are shown shaded. However, unlike the previous example, the width of each sub-template of an upper boundary subblock is wider than the width of an upper boundary subblock, and the length of each sub-template of a left boundary subblock is longer than the length of a left boundary subblock. As a result, each sub-template of a boundary subblock overlaps with overlapping neighboring samples of up to two adjacent sub-templates of boundary subblocks. Further illustrated in FIG. 24, sub-template 0 is denoted as sub0_l, sub0 and sub0_r; sub-template 1 is denoted as sub1_l, sub1 and sub1_r; sub-template 2 is denoted as sub2_l, sub2 and sub2_r; and sub-template 3 is denoted as sub3_l, sub3 and sub3_r. Here, sub1_l constitutes overlapping neighboring samples for sub0; sub0_r and sub2_l constitute overlapping neighboring samples for sub1; sub1_r and sub3_l constitute overlapping neighboring samples for sub2; and sub2_r constitutes overlapping neighboring samples for sub3.

FIG. 25 illustrates that, when fusing the sub-templates to get the template, a weighted average is computed for a sub-template and an overlapping sub-templates. The weights for samples of a non-leftmost, non-rightmost, non-uppermost, and non-lowermost sub-template and its overlapping neighboring samples, respectively, can be a and b; where a+2b may be a power of 2 to avoid division, as samples of a sub-template are weighted with overlapping neighboring samples from both sides. For the leftmost, rightmost, uppermost, and lowermost sub-templates, the weights for samples of the sub-template and its overlapping neighboring samples, respectively, can be a and 2b or a+b and b; where a+2b may be a power of 2 to avoid division, as center samples are only weighted with overlapping neighboring samples from one side rather than both sides. After constructing a template for a reference picture list, two reference picture list templates can be combined to get a final template, and the TM cost is calculated by the final template of the reference block and the template of the current block.

In the MV search process, different subblocks have different subblock MVs, and thus they can have different MV offsets. However, the template is only related with the MVs of the boundary subblock. Thus, in one embodiment, template matching is performed to refine MVs of boundary subblocks, but not non-boundary subblocks.

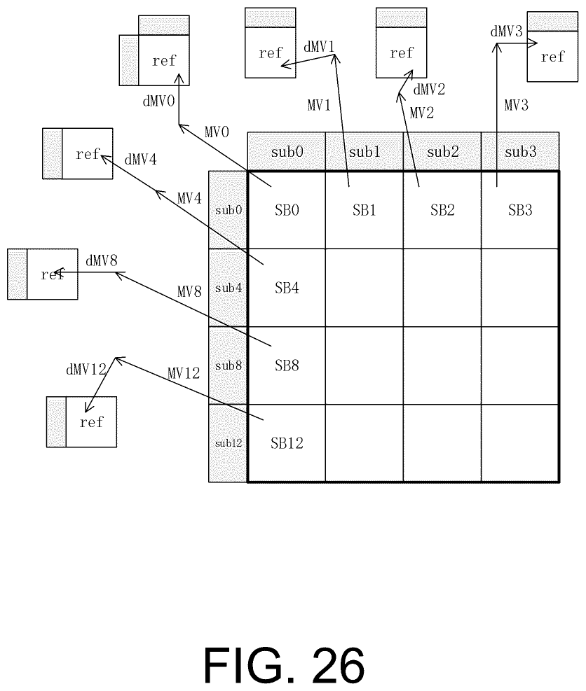

FIG. 26 illustrates that the upper boundary subblocks and left boundary subblocks SB0, SB1, SB2, SB3, SB4, SB8 and SB12 have respective motion vectors MV0, MV1, MV2, MV3, MV4, MV8 and MV12 to get their respective sub-templates. During the MV search process, an independent offset can be determined for each subblock by applying an independent motion shift. dMV0 is added to MV0 to get a new sub-template; dMV1 is added to MV1 to get a new sub-template; dMV2 is added to MV2 to get a new sub-template; dMV3 is added to MV3 to get a new sub-template; dMV4 is added to MV4 to get a new sub-template; dMV8 is added to MV8 to get a new sub-template; and dMV12 is added to MV12 to get a new sub-template. These sub-templates can collectively constitute a new template, and a new TM cost can be calculated based on the new template. The new TM cost is corresponding to the MV offset group (dMV0, dMV1, dMV2, dMV3, dMV4, dMV8, dMV12). The MV offsets group producing the minimum TM cost is the MV offsets obtained in the TM process and added to the initial boundary subblock MVs to get refined boundary subblock MVs.

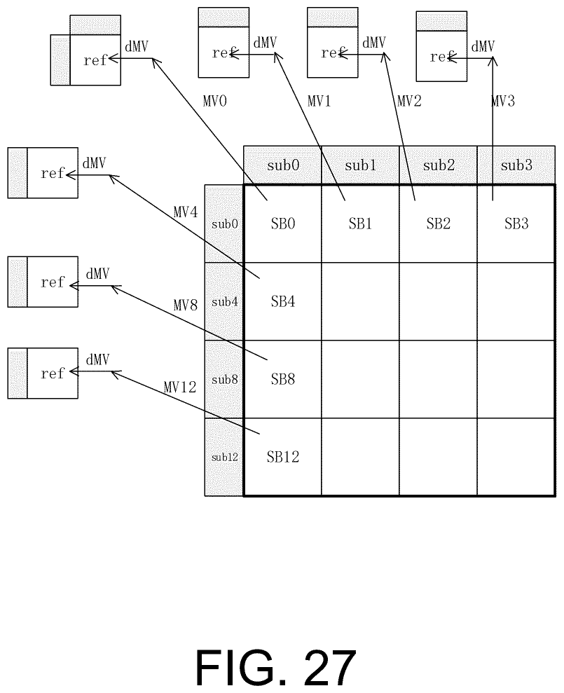

As each boundary subblock can have different MV offsets, the search complexity is especially high. To control the complexity, in some embodiments, all the boundary subblocks share the same MV offset: each sub-template has the same motion shift during the MV search process, such that the template is shifted as whole during the MV search process. FIG. 27 illustrates that a same MV offset dMV is added to all the boundary subblock MVs to get sub-templates. As there is only one MV offset to be searched, the template-matching search method for the regular coding block can be used.

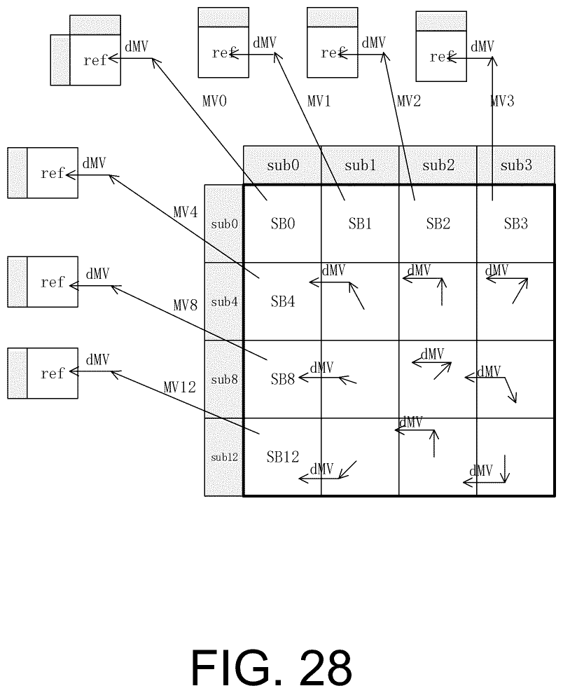

If all the subblock MVs are shifted by a same offset, then this MV offset can also be applied to the MVs of non-boundary subblocks, although the non-boundary subblock MVs do not contribute to the template. As shown in FIG. 28, the MV offset dMV is added to all the subblock MVs. Thus, in this embodiment, the boundary subblock MVs are used to get a template and to search for one MV offset for all the boundary subblock MVs during the refinement, and after refinement the optimal MV offset is applied to all the subblock MVs.

When searching for the MV offset during TM process, any search pattern as described above can be used. By way of example, a 3×3 cross search or a 3×3 square search as illustrated in FIG. 11 above can be used. Alternatively, the search patterns illustrated in FIGS. 14A and 14B can also be applied.

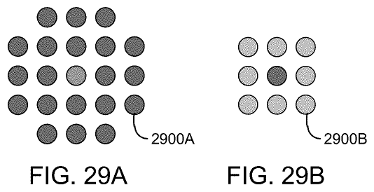

The search process may be divided into integer search process in which the search step is an integer pixel distance and fractional search process in which search step is a fractional pixel distance. As illustrated by FIG. 29A, only the twenty shown positions 2900A surrounding the initial position at the center are searched. The position with the minimum TM cost is found as the best position in the integer search and it is set as the initial position in the following fractional search process. To reduce the complexity, as illustrated by FIG. 29B, the 8 half-pixel positions 2900B surrounding the best integer position at the center are searched in the fractional search process. The position with the minimum TM cost is found as the best position in the fractional search and output as the optimal position, and the corresponding MV offset is added to all subblock MVs to get refined subblock MVs.

To further reduce the search complexity, in some other embodiments, the neighboring positions to be searched of a search iteration is reduced adaptively according to the previous search iteration. For example, in the 3×3 cross search scheme, there are four neighboring positions to be searched in each search iteration. Suppose the current center is (a, b) and the eight neighboring positions to be checked are pa0=(a+s, b), pa1=(a−s, b), pb0=(a, b+s), pb1=(a, b−s), respectively. The template matching cost of four neighboring positions are denoted as cost_pa0, cost_pa1, cost_pb0, cost_pb1.

A VVC-standard encoder and decoder configure one or more processors of a computing system to compare cost_pa0 and cost_pa1: if cost_pa0 is less than cost_pa1, then only positive offsets are considered for parameter a in the next iteration; if cost_pa0 is greater than cost_pa1, then only negative offsets are considered for parameter a in the next iteration.

A VVC-standard encoder and decoder configure one or more processors of a computing system to compare cost_pb0 and cost_pb1: if cost_pb0 is less than cost_pb1, then only positive offsets are considered for parameter b in the next iteration; if cost_pb0 is greater than cost_pb1, then only negative offsets are considered for parameter b in the next iteration.

A VVC-standard encoder and decoder configure one or more processors of a computing system to compare cost_pc0 and cost_pc1: if cost_pc0 is less than cost_pc1, then only positive offsets are considered for parameter c in the next iteration; if cost_pc0 is greater than cost_pc1, then only negative offsets are considered for parameter c in the next iteration.

A VVC-standard encoder and decoder configure one or more processors of a computing system to compare cost_pd0 and cost_pd1: if cost_pd0 is less than cost_pd1, then only positive offsets are considered for parameter d in the next iteration; if cost_pd0 is greater than cost_pd1, then only negative offsets are considered for parameter d in the next iteration.

Suppose for the current search iteration, cost_pa0 is less than cost_pa1, and cost_pb0 is greater than cost_pb1. Then, in the next round the two neighboring positions to be checked are (a′+s, b′), (a′, b′−s) where (a′, b′, c′, d′) is the center position of the next search iteration.

In some other embodiments, the minimum template matching cost of the current search iteration is compared with that of a previous search iteration, or compared with that of a previous search iteration multiplied by a factor f. If the minimum template matching cost reduction is a small amount, i.e., the minimum template matching cost is not reduced by more than a threshold, the search terminates. For example, if the cost of a previous search iteration is A which means the cost of the current search center is A, the minimum template matching cost of the neighboring positions is B at position posb, where B<A. According to this search rule, the search goes to the next iteration with search center posb. However, in this embodiment, if A−B<K or B>A×f, the search terminates and the posb is selected as the optimal position of this search iteration. K and f are pre-set thresholds. For example, f is a factor less than 1, such as 0.95, 0.9 or 0.8.

QP controls the quantization in video coding. With a higher QP, a bigger quantization step is used, and thus more distortion is introduced. Thus, for a higher QP, more search iterations are needed in the refinement, increasing encoding time. To reduce total coding time, in this embodiment, a smaller maximum search iteration threshold is set at a higher QP than at a lower QP.

Other methods for reducing complexity may also be used at high QP. For example, reducing the neighboring positions to be searched; adaptively reducing the search iteration; or early-terminating the search dependent on the previous search process may be implemented. Thus, in this embodiment, different search strategies may be adopted at different QPs.

The search rounds may also be dependent on the sequence resolution. For example, for video sequences with large resolution, the maximum search iteration threshold or the neighboring positions to be searched in each round is set to a large value, and for video sequences with small resolution, the maximum search iteration threshold or the neighboring positions to be searched in each round is set to a small value. In another example, the refinement for the small resolution video sequences is disabled. That is, whether TM based refinement on subblock merge block is enabled depends on the resolution of video sequences.

An inter-coded frame, such as a B frame or a P frame, has one or more reference frames. The time distance between the current frame and reference frame impacts the accuracy of the inter prediction. The time distance between two frames in video coding is usually represented by POC distance. Usually, with a longer POC distance, the inter prediction accuracy is lower and the motion information accuracy is also lower, and thus it needs more refinement. Thus, in this embodiment, the search process depends on the POC distance between the current frame and the reference frame.

For a hierarchical B frame, the frame with a higher temporal layer has short POC distance to the reference frame and the frame with a lower temporal layer has longer POC distance to the reference frame. Thus, the search process can also depend on the temporal layer of the current frame. For example, affine parameter refinement can be disabled for a high temporal layer, as a high temporal layer has short POC distance to the reference frame and may not need refinement. In another example, a small search iteration threshold is set, or neighboring search positions are reduced, for a high temporal layer frame.

Also, other methods to reduce the complexity of parameter refinement can be used for the high temporal layer frame. Thus, in this embodiment, the parameter refinement process depends on the temporal or the POC distance between the current frame and the reference frame.

After the subblock MV refinement, the TM cost costA can be compared with the TM cost with initial subblock MVs which is denoted as cost0. Only if costA<h×cost0 where h is a factor less than 1, the refined subblock MVs are used for the motion compensation; otherwise the initial subblock MVs are used for the motion compensation, meaning the refinement is recovered.

In some embodiments, the TM cost is extended by taking MV offset into consideration to penalize a search position far away from the initial position. The MV offset here refers to the difference between the refined MV and the initial MV. Thus, larger MV refinements proportionally apply larger template matching costs, preventing the refined MV from deviating too far from the initial MV which is derived from the neighboring blocks.

Assume the MV offset obtained in the subblock MVs search process is dMV=(mvₓ, mv_{y}). The MV cost, denoted as cost(MV), can be derived by Equation 16 below:

$$cost ( MV ) = ( \vert mv 0 \vert + \vert mv {0}_{y} \vert )$$

and TM cost, denoted as cost(TM), can be a weighted sum of MV cost and sample cost, by Equation 17 below:

$$cost ( TM ) = cost ( sample ) + w \times Cost ( MV )$$

The sample cost is derived according to the sample difference between the template of the current block and the template of the reference block. It can be a SAD or a SATD of the two templates.

Persons skilled in the art will appreciate that all of the above aspects of the present disclosure may be implemented concurrently in any combination thereof, and all aspects of the present disclosure may be implemented in combination as yet another embodiment of the present disclosure.

FIG. 30 illustrates an example system 3000 for implementing the processes and methods described above for implementing template-matching-based motion refinement.

The techniques and mechanisms described herein may be implemented by multiple instances of the system 3000 as well as by any other computing device, system, and/or environment. The system 3000 shown in FIG. 30 is only one example of a system and is not intended to suggest any limitation as to the scope of use or functionality of any computing device utilized to perform the processes and/or procedures described above. Other well-known computing devices, systems, environments and/or configurations that may be suitable for use with the embodiments include, but are not limited to, personal computers, server computers, hand-held or laptop devices, multiprocessor systems, microprocessor-based systems, set top boxes, game consoles, programmable consumer electronics, network PCs, minicomputers, mainframe computers, distributed computing environments that include any of the above systems or devices, implementations using field programmable gate arrays (“FPGAs”) and application specific integrated circuits (“ASICs”), and/or the like.

The system 3000 may include one or more processors 3002 and system memory 3004 communicatively coupled to the processor(s) 3002. The processor(s) 3002 may execute one or more modules and/or processes to cause the processor(s) 3002 to perform a variety of functions. In some embodiments, the processor(s) 3002 may include a central processing unit (“CPU”), a graphics processing unit (“GPU”), both CPU and GPU, or other processing units or components known in the art. Additionally, each of the processor(s) 3002 may possess its own local memory, which also may store program modules, program data, and/or one or more operating systems.

Depending on the exact configuration and type of the system 3000, the system memory 3004 may be volatile, such as RAM, non-volatile, such as ROM, flash memory, miniature hard drive, memory card, and the like, or some combination thereof. The system memory 3004 may include one or more computer-executable modules 3006 that are executable by the processor(s) 3002.

The modules 3006 may include, but are not limited to, one or more of an encoder 3008 and a decoder 3010.

The encoder 3008 may be a VVC-standard encoder implementing any, some, or all aspects of example embodiments of the present disclosure as described above, and executable by the processor(s) 3002 to configure the processor(s) 3002 to perform operations as described above.

The decoder 3010 may be a VVC-standard encoder implementing any, some, or all aspects of example embodiments of the present disclosure as described above, executable by the processor(s) 3002 to configure the processor(s) 3002 to perform operations as described above.

The system 3000 may additionally include an input/output (“I/O”) interface 3040 for receiving image source data and bitstream data, and for outputting reconstructed pictures into a reference picture buffer or DPB and/or a display buffer. The system 3000 may also include a communication module 3050 allowing the system 3000 to communicate with other devices (not shown) over a network (not shown). The network may include the Internet, wired media such as a wired network or direct-wired connections, and wireless media such as acoustic, radio frequency (“RF”), infrared, and other wireless media.

Some or all operations of the methods described above can be performed by execution of computer-readable instructions stored on a computer-readable storage medium 3030, as defined below. The term “computer-readable instructions” as used in the description and claims, include routines, applications, application modules, program modules, programs, components, data structures, algorithms, and the like. Computer-readable instructions can be implemented on various system configurations, including single-processor or multiprocessor systems, minicomputers, mainframe computers, personal computers, hand-held computing devices, microprocessor-based, programmable consumer electronics, combinations thereof, and the like.

The computer-readable storage media may include volatile memory (such as random-access memory (“RAM”)) and/or non-volatile memory (such as read-only memory (“ROM”), flash memory, etc.). The computer-readable storage media may also include additional removable storage and/or non-removable storage including, but not limited to, flash memory, magnetic storage, optical storage, and/or tape storage that may provide non-volatile storage of computer-readable instructions, data structures, program modules, and the like.

A non-transient or non-transitory computer-readable storage medium is an example of computer-readable media. Computer-readable media includes at least two types of computer-readable media, namely computer-readable storage media and communications media. Computer-readable storage media includes volatile and non-volatile, removable and non-removable media implemented in any process or technology for storage of information such as computer-readable instructions, data structures, program modules, or other data. Computer-readable storage media includes, but is not limited to, phase change memory (“PRAM”), static random-access memory (“SRAM”), dynamic random-access memory (“DRAM”), other types of random-access memory (“RAM”), read-only memory (“ROM”), electrically erasable programmable read-only memory (“EEPROM”), flash memory or other memory technology, compact disk read-only memory (“CD-ROM”), digital versatile disks (“DVD”) or other optical storage, magnetic cassettes, magnetic tape, magnetic disk storage or other magnetic storage devices, or any other non-transmission medium that can be used to store information for access by a computing device. In contrast, communication media may embody computer-readable instructions, data structures, program modules, or other data in a modulated data signal, such as a carrier wave, or other transmission mechanism. A computer-readable storage medium employed herein shall not be interpreted as a transitory signal itself, such as a radio wave or other free-propagating electromagnetic wave, electromagnetic waves propagating through a waveguide or other transmission medium (such as light pulses through a fiber optic cable), or electrical signals propagating through a wire.

The computer-readable instructions stored on one or more non-transient or non-transitory computer-readable storage media that, when executed by one or more processors, may perform operations described above with reference to FIGS. 1A-29B. Generally, computer-readable instructions include routines, programs, objects, components, data structures, and the like that perform particular functions or implement particular abstract data types. The order in which the operations are described is not intended to be construed as a limitation, and any number of the described operations can be combined in any order and/or in parallel to implement the processes.

Although the subject matter has been described in language specific to structural features and/or methodological acts, it is to be understood that the subject matter defined in the appended claims is not necessarily limited to the specific features or acts described. Rather, the specific features and acts are disclosed as exemplary forms of implementing the claims.

What is claimed is:

1. A computing system, comprising:
one or more processors, and
a computer-readable storage medium communicatively coupled to the one or more processors, the computer-readable storage medium storing computer-readable instructions executable by the one or more processors that, when executed by the one or more processors, perform associated operations comprising:
constructing a template of a reference block of a coding block by deriving respective sub-templates of an upper boundary subblock or a left boundary subblock of the coding block.

2. The computing system of claim 1, wherein deriving respective sub-templates of an upper boundary subblock or a left boundary subblock comprises:
determining a motion vector of a sub-template of an upper boundary subblock or a sub-template of a left boundary subblock, and
determining a sub-template based on the motion vector.

3. The computing system of claim 1, wherein deriving respective sub-templates of an upper boundary subblock or a left boundary subblock comprises:
determining a motion vector of an upper boundary subblock or a left boundary subblock, and
determining a sub-template based on the motion vector.

4. The computing system of claim 3, wherein deriving a motion vector of an upper boundary subblock or a left boundary subblock comprises:
deriving, for a uni-predicted subblock, a motion vector of either reference picture list 0 or reference picture list 1; and
deriving, for a bi-predicted subblock, two respective motion vectors of reference picture list 0 and reference picture list 1.

5. The computing system of claim 1, wherein the operations further comprise:
deriving a template of reference picture list 0 comprising at least one sub-template derived from a motion vector of reference picture list 0; and
deriving a template of reference picture list 1 comprising at least one sub-template derived from a motion vector of reference picture list 1.

6. The computing system of claim 5, wherein the operations further comprise:
deriving a final template for by computing a weighted average of the template of reference picture list 0 and the template of reference picture list 1.

7. The computing system of claim 6, wherein computing the weighted average of the template of reference picture list 0 and the template of reference picture list 1 comprises:
computing a weighted average of the at least one sub-template derived from a motion vector of reference picture list 0 and the at least one sub-template derived from a motion vector of reference picture list 1.

8. The computing system of claim 5, wherein the operations further comprise:
deriving a final sub-template for a uni-predicted subblock by taking a sub-template derived from a motion vector of reference picture list 0 or a motion vector of reference picture list 1; or
deriving a final sub-template for a uni-predicted subblock by computing a weighted average of a first sub-template derived from a motion vector of reference picture list 0 or a motion vector of reference list 1 and a second sub-template derived from the default motion vector.

9. The computing system of claim 1, wherein a sub-template of an upper boundary subblock is wider than the upper boundary subblock, and a sub-template determined of a left boundary subblock is longer than the left boundary subblock.

10. The computing system of claim 9, wherein a sub-template of the upper boundary subblock overlaps with up to two sub-templates of adjacent upper boundary subblocks, and a sub-template of the left boundary subblock overlaps with up to two sub-templates of adjacent left boundary subblocks.

11. The computing system of claim 10, wherein the operations further comprise:
deriving an upper template by fusing the sub-template of the upper boundary subblock with an overlapping sub-template, or
deriving a left template by fusing the sub-template of the left boundary subblock with an overlapping sub-template.

12. The computing system of claim 11, wherein fusing a sub-template of a non-leftmost and non-rightmost upper boundary subblock with an overlapping sub-templates, and fusing a sub-template of a non-uppermost and non-lowermost upper boundary subblock with an overlapping sub-templates, comprises computing a weighted average of the sub-template and the overlapping sub-template wherein the overlapping sub-template has a weight of b; and
wherein fusing a sub-template of a leftmost or rightmost upper boundary subblock with an overlapping sub-template, and fusing a sub-template of an uppermost or lowermost left boundary subblock with an overlapping sub-template, comprises computing a weighted average of the sub-template and the overlapping sub-template wherein the overlapping sub-template has a weight of 2b.

13. The computing system of claim 5, wherein the operations further comprise:
refining a motion vector of an upper boundary subblock or a left boundary subblock based on a template matching (“TM”) cost, wherein the TM cost comprises a difference between a template of the coding block and the template of the reference block.

14. The computing system of claim 13, wherein refining a motion vector further comprises adding respectively independent offsets to respective motion vectors of each subblock.

15. The computing system of claim 13, wherein refining a motion vector further comprises adding a same offset is added to respective motion vectors of each subblock.

16. The computing system of claim 13, wherein refining the motion vector comprises performing a motion vector search wherein the motion vector search comprises searching twenty integer pixel distance positions around an initial position to determine a best integer pixel distance position.

17. The computing system of claim 16, wherein performing the motion vector search further comprises searching eight half-pixel distance positions around a best integer pixel distance position to determine an optimal position.

18. The computing system of claim 13, wherein refining the motion vector comprises performing a motion vector search wherein the motion vector search is performed iteratively, and an iteration of the motion vector search comprises searching eight integer pixel distance positions around a best integer pixel distance position to determine an optimal position.

19. The computing system of claim 13, wherein refining the motion vector comprises performing a motion vector search wherein the motion vector search is performed iteratively and the motion vector search terminates in the event that a subsequent iteration fails to reduce minimum template matching cost by a threshold.

20. The computing system of claim 13, wherein the motion vector search is performed for fewer iterations for a higher quantization parameter (“QP”), and is performed for more iterations for a lower QP.
